(19) United States
(12) Patent Application Publication
(10) Pub. No.: US 2020/0329654 A1
(43) Pub. Date: Oct. 22, 2020

(54) SYSTEM AND METHOD FOR VERTICAL FARMING

(71) Applicant: Zadiance LLC, Bozeman, MT (US)

(72) Inventors: Samuel Westlind, Bozeman, MT (US); Michael DeChellis, Livingston, MT (US); Meghan Pieper, New Brighton, MN (US)

(21) Appl. No.: 16/772,854

(22) PCT Filed: Nov. 20, 2018
(86) PCT No.: PCT/US2018/062035

§ 371 Date: Jun. 15, 2020

Related U.S. Application Data
(60) Provisional application No. 62/763,107, filed on Dec. 15, 2017.

(51) Int. Cl. A01G 31/02; A01G 22/25; A01G 20/20; A01G 9/02

(52) U.S. Cl. CPC A01G 31/02; A01G 22/25; A01G 24/46; A01G 9/025; A01G 20/20

(57) ABSTRACT

A vertical farming system is disclosed herein. The vertical farming system can comprise a frame configured to fit into an enclosed growing environment. The vertical farming system can further comprise a track supported by the frame, where the track is configured to provide side access. The vertical farming system also includes an irrigation conduit coupled to the frame adjacent to the track. The vertical farming system includes a growth media field where the growth media field includes brackets coupled to a top portion of the growth media field. The growth media field can be made of porous material configured to form a root zone environment support and provide fluid distribution to root systems. The brackets can be configured to slidably couple to one or more tracks such that the growth media field is suspended from the one or more tracks.

### RELATED APPLICATION

This present application is a National Phase entry of PCT Application No. PCT/US2018/062035 filed Nov. 20, 2018 which claims priority to U.S. Provisional Application No. 62/763,107 filed Dec. 15, 2017 the contents of each being incorporated herein by reference in their entireties

### TECHNICAL FIELD

This invention relates generally to vertical farming apparatus and methods, and, more particularly, the invention relates to a vertical hydroponic plant production.

### BACKGROUND

Conventional farming is subject to environmental constraints such as weather, drought, water supply, soil quality and nutrients, light source and pests. There have been many improvements in farming aimed at relieving or removing these restraints, e.g. irrigation, fertilization, etc. A subset of the agricultural industry has developed around indoor warehouse farming or Controlled Environment Agriculture (“CEA”) in order to further remove these constraints. CEA technology aims to expand localized, year round production, crop variety and availability and to more precisely control growth environments and harvest timing for these crops. CEA technology comes with its own set of constraints, however.

Conventionally, hydroponic farming requires creating artificial growth environments and has thus been subject to space constraints. Vertical type hydroponic farming uses vertical stacked tray and tower hydroponic agriculture to increase the grow-able area in a given footprint in an attempt to address the issue of poor volumetric space utilization in hydroponic agriculture. CEA utilizes indoor farming methods with climate control and artificial lighting often in combination with vertical type hydroponic farming.

In one improvement in the industry a ground based tower system is used. In tower systems, a hollow tube with a single slot in the front of tube is used. The hollow tube is filled with a media fiber and seed plugs are then inserted into the single slot. To create a double sided row, however, 2 towers, stacked back to back, must be used. A double stacked row can be a poor utilization of space. Further, the tower system is one size, thus limiting the types of crop that can be grown. Further, the tower system incurs high manual labor costs, high component costs, inefficient floor maintenance practices, and is ultimately a static system. High manual labor costs result from needing multiple steps to load and unload the crops and service the towers. The tower system suffers from a high component cost as each tower structure supports only one row of crop. The tower system is subject to poor work flow and floor maintenance practices as the system is ground based and thus results in floor obstacles making foot traffic and floor maintenance difficult. Further the tower system is static, meaning each tower has to be manually moved to service, seed and harvest.

In another improvement in the industry the ground based aeroponic panes are used. The aeroponic panes include a static, rigid pane with multiple rows that is coupled to a panel enclosure to create a rigid vertical pane aeroponic system. The rigid panel enclosure requires a costly assembly and only supports low anchorage plug type crops, such as greens.

In yet another improvement in the industry a ground based linear and moveable system with top mounted supports is used. These systems require the use of root impervious support board in order to address top mounting and motion forces. The board, while rigid and supportive, does not allow moisture and root anchorage limiting root growth to low anchorage plant plug type crops. Thus, the irrigation must include the use of separate water channels between the support boards and crop type is limited to low anchorage plug type crops such as greens. Further, the support boards are mounted as one unit, thus support boards cannot function independently. Further, the single, top mounting system only allows mounting from the ends of the system.

Vertical agriculture has improved since its inception but there are still problems within the industry: Poor volumetric utilization of a given space, high cost assemblies, heavy materials, high labor costs, limited output, limited crop types and conventional systems are static or limited mobility systems.

None of the described systems are fundamentally capable of reducing agriculture crop production to the efficiency of assembly line processes.

### SUMMARY

The present invention is a vertical farming system for allowing vertical field hydroponic farming crop production.

The vertical farming system can be configured to form a root zone environment, support and provide fluid distribution of crops via a suspended, multilayered growth media within an agricultural environment. The multilayered growth media including a root system anchorage layer configured to support and provide fluid distribution to the root systems of crops, and a supporting layer or film fixed to an exterior surface of the root system anchorage layer. In embodiments, the supporting film configured to act as a containment barrier for the root zone environment, fluid distribution within the root system anchorage layer and to promote a distribution of stress from the one or more track engaging brackets across the exterior surface of the root system anchorage layer. In some embodiments the vertical farming system includes a suspended track and can include one or more tracks. The vertical farming system can also includes a multilayered growth media slidably coupled to the suspended track via one or more track engaging brackets.

The vertical farming system is configured to maximize an available growth surface within the confines of an agricultural environment. The vertical farming system can comprise a frame configured to fit into an enclosed growing environment. The vertical farming system can further comprise a track supported by the frame, where the track includes one or more channels and the one or more channels are configured to provide side access. The vertical farming system also includes an irrigation conduit coupled to the frame adjacent to the track. The vertical farming system includes a growth media field where the growth media field includes brackets coupled to a top portion of the growth media field. The growth media field can be made of porous material configured to form a root zone environment support and provide fluid distribution to root systems. The brackets can be configured to slidably couple to one or more tracks such that the growth media field is suspended from the one or more tracks.

In some embodiments, the growth media field can be a variety of lengths. The variety of lengths can include a single stack, discrete sections, and/or a continuous roll.

In one embodiment, the growth media field includes one or more layers of material and can be considered a multilayered growth media. The one or more layers of the growth media field can be coupled using brackets, adhesive, micromechanical adhesion, and/or hook and loop fixation.

In some embodiments, the one or more layers of the growth media field include a support layer coupled to an exterior surface of the growth media field. The support layer can be constructed of BoPET film and can have a thickness between about 25.4 and about 4000 μm.

The support layer or film can include a reflective surface. Additionally, one of the layers of the growth media field is constructed of synthetic reticulated foam. In one embodiment, one of the layers of the growth media field are constructed of polymer bound material.

In some embodiments, the support layer includes a plurality of perforations. In an alternative embodiment, the perforations of the support layer are arcuate.

In some embodiments, the growth media field includes a plurality of apertures, the apertures being sized and shaped to support one or more plant plug. In some embodiments, the apertures are sized and shaped to support one or more plant plug and each aperture corresponding to one of the plurality of perforations of the support layer.

In one embodiment, the growth media field includes two or more single stacks, the stacks being coupled to form a linear aperture plant site. The stacks can additionally use a Z bracket to couple layers and control linear aperture gap.

In some embodiments, the support layer includes a printable surface wherein the support layer includes printed plant sites.

Additionally, the root zone environment is formed between the track bottom (top barrier), the independently moveable multilayered growth media (side and end barriers) and the gutter (bottom barrier). The root zone environment is unobstructed, stable and actively controlable along the entire field length, even as the multilayered growth media physically advance. The root zone environment can be precisely controlled to optimize temperature, humidity, gases and fluids throughout a series of environmental conditions representative of an ideal growing season.

In some embodiments, the root zone environment is several distinct layers. The BoPET film is the exterior root zone environment barrier layer. The foam is the middle root zone layer. The polymer bound media is an interior transition zone layer. The air gap between the fields is the innermost root zone. The foam is a distinct root zone. The incorporated polymer bound media is a distinct root zone that separates the foam root zone and polymer bound root zone from the field interior air gap root zone that exists between fields. All root zones can be controlled within the root zone environment.

The root zone environment can be independently controlled within an agricultural environment.

Additionally, the growth media field can be constructed for a specific crop root requirements for growing on a vertical face thus allowing a multitude of new crops to be grown in a CEA environment. Media field dimensions such as field thickness can accommodate any crop class simply by identifying crops by root anchorage requirements of: low, medium and high. For example, a low anchorage crop such as greens or a cereal such as wheat can be a thinner field. Medical marijuana with its larger, heavier canopy requires a thicker field. Root vegetables require a thick polymer bound media field.

Additionally, layers can be added to accomplish the same and additionally create field surfaces, field instrumentation, printable layers, field strata, apertures, other geographic features, hydrophilic zones, wicking, aerobic zones, root barriers, and moisture barriers. The growth media serves to provide structure and to irrigate the vertical farming system. Growth media can also be wrapped around a cylinder and placed onto the track system. A metered pipe is placed at the apex of the growth media provides metered fluids. The metered pipe can also serve to deliver gases such as carbon dioxide, nitrogen etc. The growth media can have brackets to suspend from an outwardly open track. The outwardly open track bottom is unobstructed and can be an additional working surface for a variety of purposes such as a upper barrier for the root zone environment, fluid distribution lines, sensor attachment, electrical line attachment and for gutter attachment. The brackets can have strain gauges to monitor field weight. The growth media stacks can have brackets such as a Z bracket to control aperture gap. The growth media can be draped over the track and doubles the thickness of the field further increasing air space for aerobic root interface. Additional media can be inserted between the fold to create a thicker root bed. The growth media can be impregnated, coated or soaked with any number of materials to improve crop production such as wicking material to ensure even distribution of water, a soil-less growth medium such as peat moss, polymer bound media and other soil amendments to improve system efficiency and crop production capabilities. The growth media can be hydro seeded and also with a slurry of any number of materials to coat media. Surface coatings can provide a seed adhesive, water barrier and light barrier and even add structural rigidity. Media layers act as apertures or rows and can also be sliced to create seeding rows for plug insertion or a seed and mix paste gun injecting, and speed loading with a seed tape and plant tape placement. For the desired amount of volume and frequency of output growth media fields can be static or in continuous movement. Seeding and harvesting can occur monthly, weekly, daily, or even hourly as the growth media field advances along the track accordingly and finally to wash, dry and harvest. The growth media can be placed in a rigid perimeter case to form an exoskeleton for easier handling and media placement. A rigid exoskeleton enables ease of use for live sales and larger scale operations. A flexible exoskeleton layer such as BoPET can add structural rigidity, spread the load bearing across the entire growth media field, a barrier for the root zone environment, control moisture and reflect valuable light back onto the crop. The BoPET can extend above the top or even the sides of the field to further control humidity, control top fluid splashout, direct fluids onto growth media and prevent algal growth on fluid conduit and media edges by preventing light intrusion. The BoPET offers ideal printable faces for human and machine datum and printable instrumentation. The lightweight growth media field can be positioned between the horizontal position and the vertical position allowing inclined, multi-angled crop production and scaled to any volumetric space available. The root system anchorage layer can have a thickness between about 0.2 and about 12 inches, wherein the root system anchorage layer can be constructed of synthetic reticulated foam. The root system anchorage layer is constructed of a polymer bound material. In some embodiments, the multilayered growth media is comprised of one or more growth media discrete sections.

In one embodiment, vertical farming can be configured to maximize available growth surface within the confines of an agricultural environment. For example, vertical farming can include suspending a growth media above the floor of a farming area. The growth media can be a pliable growth field with a dual sided exterior growing surface. Further, the growth field can include an interior that can be configured to support and provide fluid distribution to root systems.

Vertical farming can include seeding the growth media over both exterior growing surfaces. Vertical farming can also include providing water and/or nourishment to the growth media via a conduit positioned proximal to a top edge of the growth media. Also, vertical farming can include providing one or more light sources configured to replicate at least a portion of the natural solar spectrum over the exterior growing surfaces.

In some embodiments, the growth media fields are movable along the one or more tracks.

In some embodiments, an enclosed growing environment is sized and shaped to enclose the vertical farm system but is small enough to fit inside of a larger enclosure.

In one embodiment, wherein the growth media field is a plurality of stacked layers, wherein the stacked layers are oriented perpendicular to the length of the track and the coupling of each layer forms an aperture configured for crop growth.

The one or more tracks of the growth media fields are configured, in some embodiments, such that the growth media fields can be coupled or uncoupled to the one or more tracks from a side position at any portion of the one or more tracks. The one or more tracks are configured to guide the growth media fields through a series of artificial lighting. The one or more tracks can be configured to guide the growth media fields through a series of environmental conditions representative of an ideal growing season. The one or more tracks can also be configured to guide the growth media fields through a series of artificial lighting and environmental conditions representative of an ideal growing season.

In some embodiments, growth media field includes a plurality of media pores configured to retain at least one plant or seed. The growth media field can be constructed of a material having a porosity of approximately 5 to 50 pores per inch. Further, the growth media field can have an interior configured to support and provide fluid distribution to root systems and including a wicking material disbursed across the media pores of the growth media field. In one embodiment, the growth media field is rigid. The media pores can also be defined as apertures extending along predefined axes to promote growth along the predefined axes for the purpose of maximizing the number of plants that can be grown on the growth media field. The growth media field can be suspended from a track, such that a non-contacting gap is defined between a bottom edge of the growth media field and a floor of the agricultural environment.

In an alternative embodiment, growth media field can be divisible into a plurality of stacked layers, wherein the stacked layers are arranged such that a channel is formed from the intersection of the stacked layers such that plant growth can occur within the channel. In other embodiments, the growth media field is continuous and configured to be loaded onto the track via a roll of growth media field. In yet another embodiment, the growth media field is a discrete section of material and is further configured to be loaded onto the track adjacent one or more other growth media fields.

In one embodiment, the growth media field includes a data tag configured to provide information relating to a crop growing on the growth media field.

In yet another embodiment, the surface layer can include a printable surface which further includes a printed electrical circuit. In some embodiments, the printed electrical circuit includes plant site monitoring sensors. The printed electrical circuit can also be configured to communicatively couple the plant site monitoring sensors to a controller.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A is an isometric view of a vertical farming system, according to embodiments described herein.

FIG. 1B is an isometric view of an automated vertical farming system, according to embodiments described herein.

FIG. 2A is an isometric view illustrating various media suspension of the vertical farm system, according to embodiments described herein.

FIG. 2B is an isometric view illustrating various media suspension of the vertical farm system, according to embodiments described herein.

FIGS. 2C-2F are top view of alternative embodiments of a vertical farm system, according to embodiments described herein.

FIG. 3A is an isometric view illustrating a sine wave track and media of the vertical farm system, according to embodiments described herein.

FIG. 3B is a cross-section view of a sine wave track and media of the vertical farm system, according to embodiments described herein.

FIG. 4 is an isometric view illustrating a broadcast seeding of the media of the vertical farm system, according to embodiments described herein.

FIG. 5 is a staged top view of a continuous production method of the vertical farm system, according to embodiments described herein.

FIG. 6A is a top view of a vertical farm system, according to embodiments described herein.

FIG. 6B is a side view of a vertical farm system, according to embodiments described herein.

FIG. 6C is an isometric view of a vertical farm system, according to embodiments described herein.

FIG. 7A is an isometric view of draped layer individual media fields, according to embodiments described herein.

FIG. 7B is a cross section view of draped layer individual media fields, according to embodiments described herein.

FIG. 7C is a side view of draped layer individual media fields, according to embodiments described herein.

FIG. 7D is a top view of an array of draped layer individual media fields, according to embodiments described herein.

FIG. 7E is an isometric view of an alternative growth media field composition, according to embodiments described herein.

FIG. 8A is an isometric view of a vertical farming system with multiple layer geography, according to embodiments described herein.

FIG. 8B is a cross section view of a vertical farming system with multiple layer geography, according to embodiments described herein.

FIGS. 8C-8G are isometric views of vertical farming systems with multiple layer geography, according to embodiments described herein.

FIG. 9A is an exploded view of vertical farming systems, according to embodiments described herein.

FIG. 9B is a side exploded view of vertical farming systems, according to embodiments described herein.

FIGS. 9C-9F are isometric view of seeding methods for vertical farming systems, according to embodiments described herein.

FIG. 10A is an isometric view of a slotted embodiment of vertical farming systems, according to embodiments described herein.

FIG. 10B is an isometric view of a slotted embodiment of vertical farming systems, according to embodiments described herein.

FIG. 10C is an isometric view of a single slot embodiment of vertical farming systems, according to embodiments described herein.

FIG. 11A is an isometric view of an alternative embodiment of vertical farming system, according to embodiments described herein.

FIG. 11B is an exploded view of an alternative embodiment of vertical farming system, according to embodiments described herein.

FIG. 11C is an isometric view of an alternative embodiment of vertical farming system, according to embodiments described herein.

FIG. 11D is an isometric close-up view of an alternative embodiment of vertical farming system, according to embodiments described herein.

FIG. 12A is a front view of a growth media field of an alternative embodiment of vertical farming system, according to embodiments described herein.

FIG. 12B is a rear view of a growth media field of an alternative embodiment of vertical farming system, according to embodiments described herein.

FIG. 12C is a cross section view of a plug aperture of an alternative embodiment of vertical farming system, according to embodiments described herein.

FIG. 12D are a cross section view of a plug aperture of an alternative embodiment of vertical farming system, according to embodiments described herein.

FIG. 13A is an isometric view of facility scale vertical farming system, according to embodiments described herein.

FIG. 13B is a front view of a plurality of growth media fields in a vertical farming system, according to embodiments described herein.

FIG. 14A is an isometric view of an alternative embodiment of vertical farming system, according to embodiments described herein.

FIG. 14B is a close up isometric view of an alternative embodiment of vertical farming system, according to embodiments described herein.

FIG. 15A is an isometric view of an alternative embodiment of vertical farming system, according to embodiments described herein.

FIG. 15B is an exploded view of an alternative embodiment of vertical farming system, according to embodiments described herein.

FIG. 15C is an isometric view of a plurality of growth media stacks in a vertical farming system, according to embodiments described herein.

FIG. 16 is an isometric view of a mini-farm enclosure of a vertical farming system, according to embodiments described herein.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

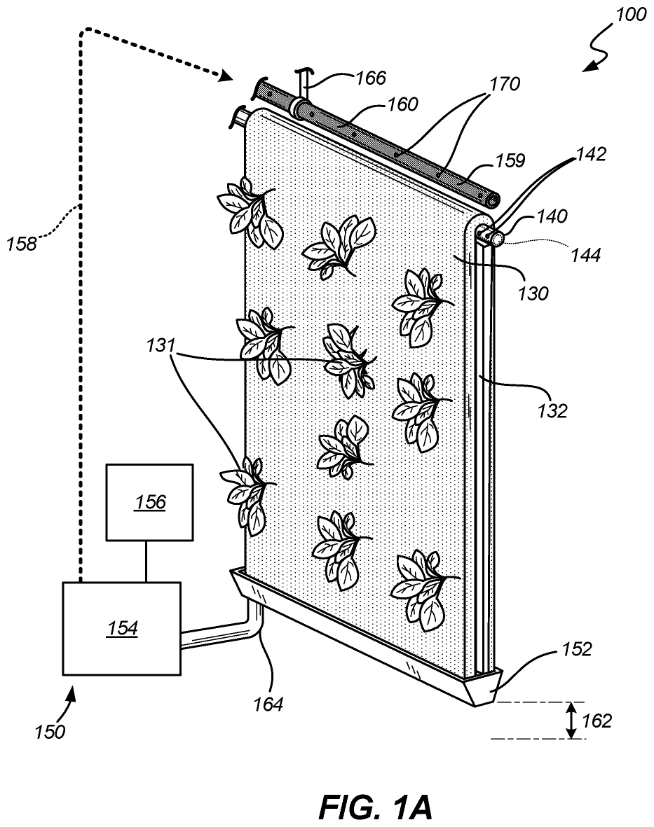

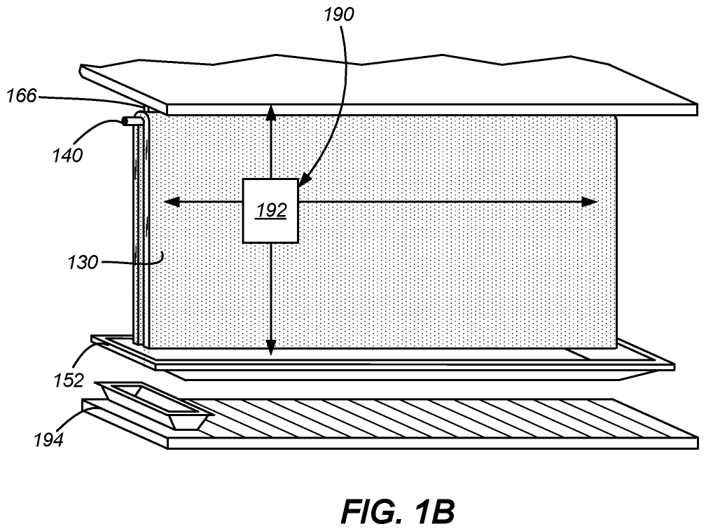

The present invention is a vertical farm system allowing vertical hydroponic crop production. Particularly, vertical hydroponic crop production described herein optimizes volumetric space and output is optimized. Various embodiments of the vertical farm system, depicted in FIGS. 1-16, maximize utilization of a given volumetric space by maximizing vertical working surfaces via a controllable unobstructed root zone environment over the entire length of field. In some embodiments, utilization of a given volumetric space is further maximized using fractal-type geometry to minimize seed spacing and maximize canopy coverage. These features to allow multi plane plant production in a minimal footprint. In other embodiments, continuous and automated farming methods can be implemented to optimize crop yield and efficiency.

Referring to FIG. 1A, an embodiment is depicted of a vertical farming system 100 configured to maximize available growth surface within the confines of an agricultural environment. Vertical farming system 100 includes a growth media field 130. Growth media field 130 can be configured to be pliable or rigid. Growth media field 130 can have dual sided exterior growing surfaces for crop 131 growth. Further, growth media field 130 can have an interior 132 configured to support and provide fluid distribution to root systems.

In embodiments, the interior 132 of growth media field 130 can be configured to form a root zone environment support and provide fluid distribution to root systems of crops 131. Interior 132 can include a wicking material disbursed across the media pores of the growth media field. In one embodiment, interior 132 can be rigid to help support growth media field 130. In an alternative embodiment, interior 132 can be flexible and/or hollow for aeroponic irrigation.

In one embodiment, growth media field 130 can be configured to suspend from a conduit 140. In embodiments, conduit 140 can be positioned horizontally at a height conducive to providing support to a top edge of the growth media field 130. Further, conduit 140 can include holes 142 arranged along conduit 140. Holes 142 can be configured to dispense water to at least interior 132 of growth media field 130. Further, conduit 140 can be configured to provide water to holes 142 via internal cavity 144.

In embodiments, growth media field 130 can be made of rPET-silica aerogel, coco coir, jute, hemp, burlap, kenaf, wool, felt, peat moss, perlite, vermiculite, rockwool, fiberglass, synthetic foams, synthetic fibers, or a combination thereof. In some embodiments, polymer bound media can be used. For example, a polymer can be used to bind a media, such as peat moss, into a structured and resilient media. With respect to synthetic foams, one example would be reticulated foam. In some embodiments, a polymer bound media can be a layer adjoining another layer such as reticulated foam. In some embodiments, a polymer bound media can be incorporated within a growth media field such as reticulated foam. Particularly, growth media field 130 can contain a plurality of media pore apertures, for example, the pore apertures found in reticulated foam. The media pore apertures can be configured to retain at least one plant seed and/or seedling plant. Further, growth media field 130 can have a porosity of approximately 8 to 10 media pores per inch. In alternative embodiments, growth media field 130 can have a porosity that is either greater than 10 pores per inch to accommodate smaller, denser crops, or have a porosity that is smaller than 8 pores per inch to accommodate larger, less dense crops. Growth media field 130 for tubers can be a denser field constructed of a polymer bound media such as polymer binder DOW® 5012 with peat moss filler. Growth media field 130 plant sites can be the pores, plug holes and between layers.

As shown in embodiments depicted in FIG. 1A, vertical farming system 100 includes a water-recycle system 150. Water-recycle system 150 includes a gutter 152, a sump reservoir 154, a pump 156, a water return 158 and a top soaker hose 159 inserted into pipe 160. In embodiments, gutter 152 is configured to house and support a bottom end of growth media field 130. In alternative embodiments, a non-contacting gap can be arranged between gutter 152 and the bottom end of growth media field 130. Further, gutter 152 is configured to collect excess water that is not absorbed by crops 131 or held by growth media field 130. In one embodiment, gutter 152 is configured to be positioned at an elevated height 162, or other non-contacting gap, such that a sump output 164 can be arranged on the bottom portion of gutter 152. In embodiments, top pipe 160 is arranged above growth media field 130 via support system 166. Pipe 160 includes an array of holes 170 arranged along pipe 160. Holes 170 may be arranged in an organized array such as linear holes, or, alternatively, can have a randomized array of holes.

In pipe 160 the holes 142, 170 are located above the bottom of the pipe 160. The oversized pipe 160, 280 will not flow until water level reaches the holes 142, 170. Thus, an overhead reservoir is created within the oversized pipe 160, 280 resulting in a zero pressure, low operational cost flood irrigation to field 130. Holes 142, 170 can disperse gases between irrigation cycles or additional holes 142, 170 above the water level height in oversized pipe 160, can be used to uniformly disperse gases such as carbon dioxide, nitrogen etc. Water-recycle system 150 is configured to capture excess water from growth media field 130 into gutter 152. Then, the excess water exits gutter 152 through sump output 164 and is directed into the sump reservoir 154. From the sump reservoir 154, water is pumped at a regulated rate through water return 158 to pipe 160. Once at pipe 160, the water is dispersed through holes 170 and onto growth media field 130 for use in absorption by crops 131. In an alternative embodiment, water return 158 is coupled to conduit 140 and configured to disperse recycled water into growth media field 130 via internal cavity 144 and holes 142. In yet another embodiment, water return 158 is coupled to both conduit 140 and pipe 160.

Referring now to FIG. 1B, an embodiment of an automated care system 190 is depicted as an alternative or addition to manual care of vertical farming system 100. In embodiments of automated care system 190, suspension system 166 can support conduit 140, growth media field 130, gutter 152, a crop care robot 192, and a harvest collection table 194. In embodiments, crop care robot 192 can be arranged along a face of growth media field 130 to manage crops. Also, crop care robot can perform harvesting or maintenance and utilize harvest collection table 194 to place plant material on for removal.

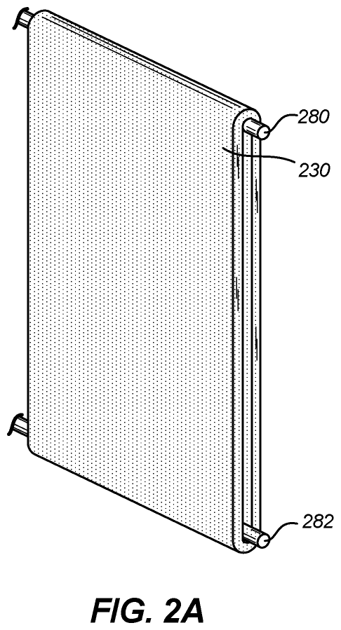

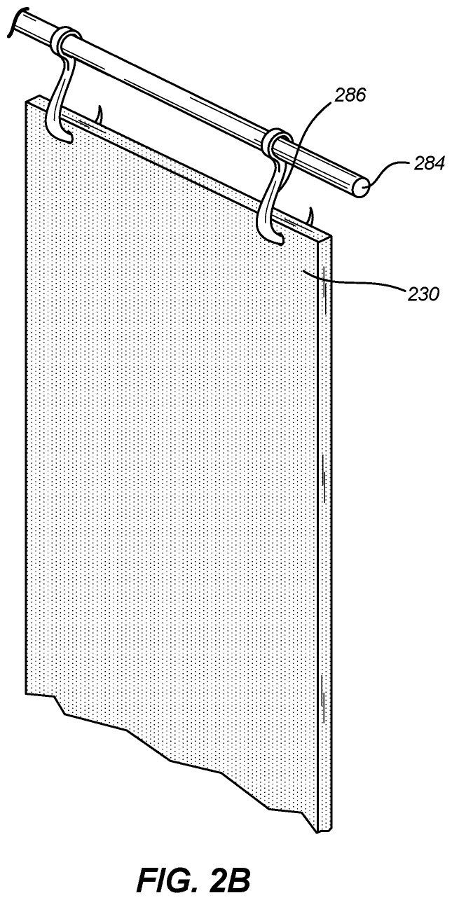

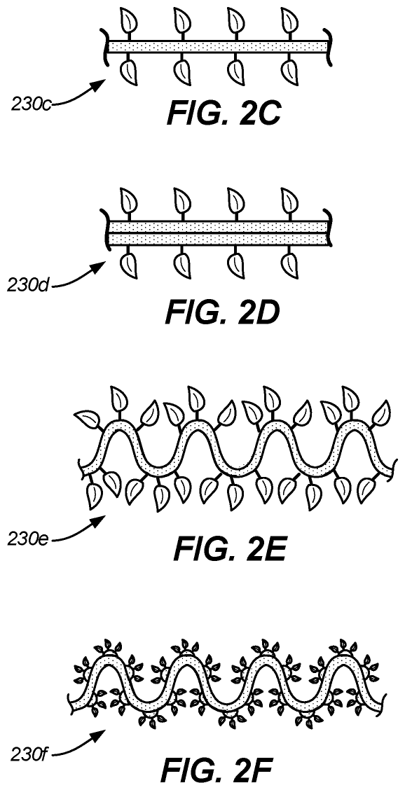

In alternative embodiments as depicted in FIGS. 2A-2F, growth media field 230 can be arranged in various configurations. Referring to FIG. 2A, growth media field 230 is configured to wrap around a top track 280 and a bottom track 282 wherein top track 280 holds growth media field 230 in a vertical position. In the embodiment depicted in FIG. 2A, a growth media field 230 and be rotated about top track 280 and bottom track 282 such that a plant growing on growth media field 230 can get access to different lighting and water areas despite its location on growth media field 230. In an alternative embodiment and referring to FIG. 2B, growth media field 230 is suspended via track 284 and one or more hooks 286. In alternative embodiments of growth media field 230 as depicted in FIGS. 2C-2F, a single growth media field 230C, a double growth media field 230D, a sine wave growth media field 230E, and fractal geometry growth media field 230F are depicted to illustrate the variety of arrangements that can be created with growth media field 230.

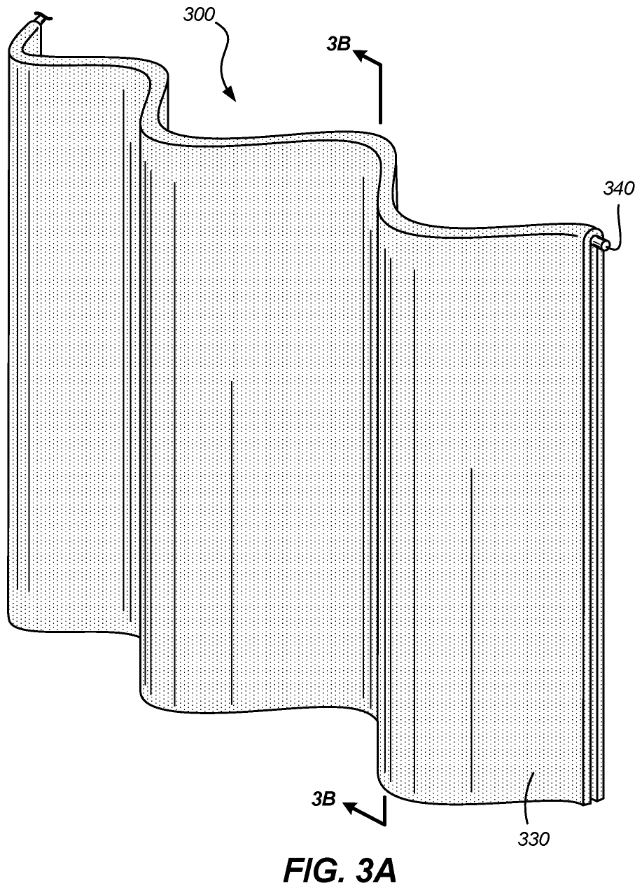

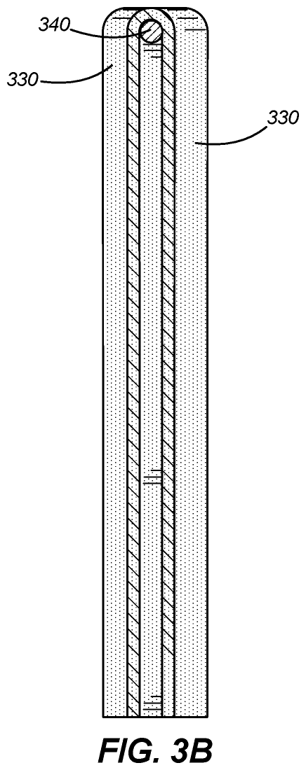

In an alternative embodiment depicted in FIGS. 3A-3B, vertical farming system 300 includes a growth media field 330. In the embodiment depicted in FIGS. 3A-3B, growth media field 330 includes a track 340. In embodiments, track 340 is shaped to maximize the growth area present on growth media field 330. In the embodiment depicted in FIGS. 3A-3B, track 340 is configured to have a sine wave shape. Because growth media field 330 is draped over track 340 and takes the shape of track 340, growth media field 330 maintains a sine wave shape and thus creates greater surface area for plant growth. In other embodiments, track 340 and growth media field 330 includes a plurality of curves other than sine wave curves and/or angles so as to increase the dual sided exterior growing surfaces within the confines of the agricultural environment.

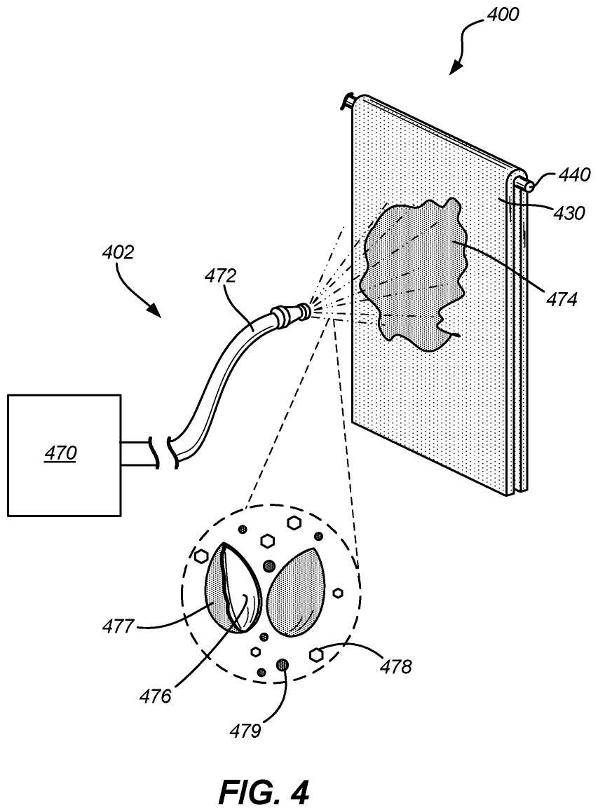

Referring now to FIG. 4, wherein a vertical farming system 400 is seeded by a broadcast seeding system 402 is depicted. FIG. 4 depicts vertical farming system 400 including growth media field 430 being suspended by track 440. In an embodiment, broadcast seeding system 402 includes a slurry pump 470 and hose 472. In embodiments, slurry pump 470 is configured to pump growth slurry 474 onto growth media field 430 such that growth slurry 474 adheres and impregnates growth media field 430. Growth slurry 474 can include any combination of mixtures of seed 476, adherent 477, loose adherent 478 and other additives 479. In some embodiments, growth slurry 474 comprises only seed 476, or only seed 476 and adherent 477. Adherent 477 and loose adherent 478 can comprise any biological adherent, for example, glucose, or any other suitable biological adherent. In embodiments, additives 479 can contain fertilizers, moisture absorption agents, spray additives, and any other additives suitable for combination with seeding and growth.

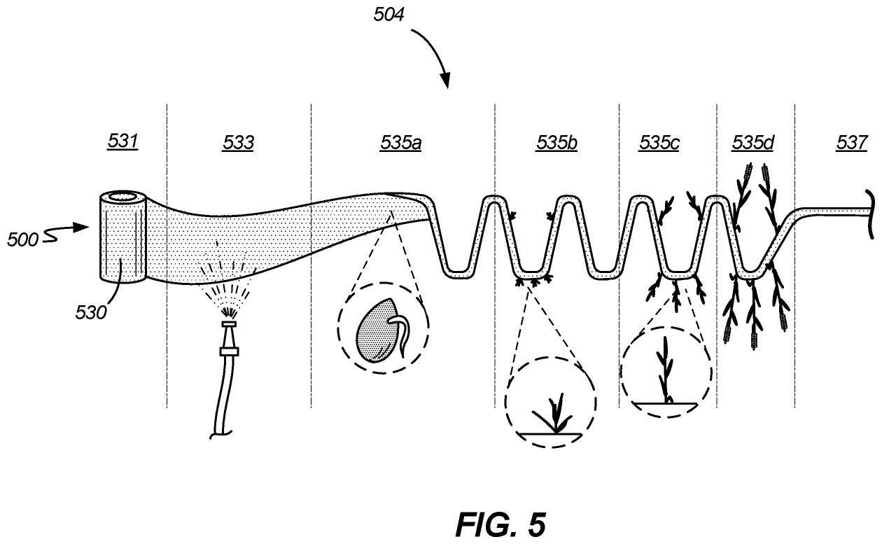

FIG. 5A depicts a vertical farming system 500 in a continuous farming process 504. Because of vertical farming systems growth media fields 530 comprising flexible material, a continuous farming process 504 can be implemented using a continuous embodiment of growth media fields 530. In step 531 of a continuous farming process 504, growth media field 530 is unrolled and oriented. In step 533, growth media field 530 is seeded using seed broadcasting. In step 535A-D, the crop is germinated in step 535A, grown in to seedlings in step 535B, grown into leafy plants in step 535C, and grown to maturity in step 535D. Then, in step 537, the crop is harvested. Continuous farming process 504 is advantageous because it reduces the need for equipment movement. This is because at each step 531-537, different equipment, lighting, and environment are needed and used and if the growth media field 530 moves throughout the different steps, the equipment needed throughout the steps does not need to move. In embodiments, crops, such as cereals are single harvest type crops and can utilize continuous embodiment of growth media fields 530.

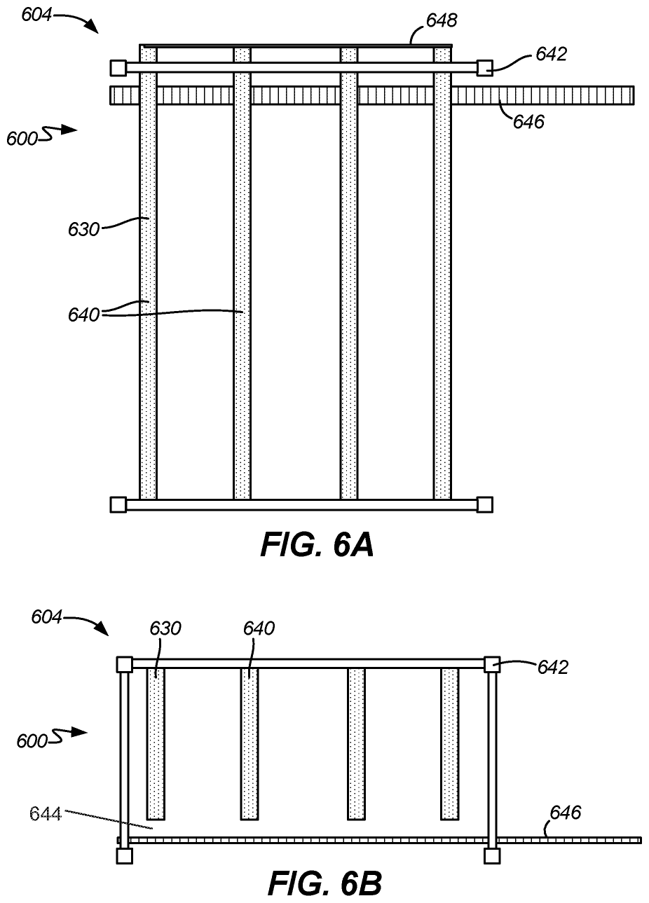

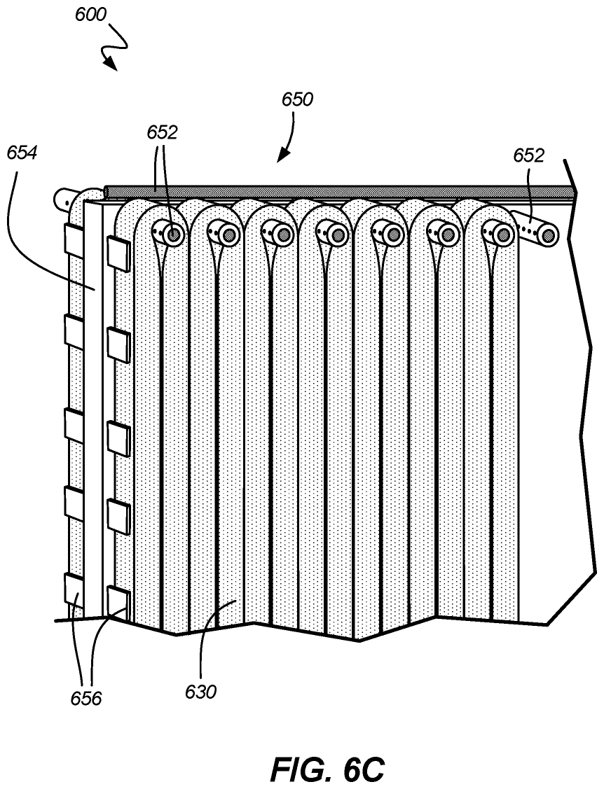

FIGS. 6A-6B depict an alternative embodiment of vertical farming system 600 in a continuous farming process 604. In the embodiments of continuous farming 604 as depicted in FIGS. 6A and 6B, growth media field 630 is cut into discrete sections 640. Sections 640 are then coupled to frame 642 such that a non contacting gap 644 formed below growth media field 630. Frame 642 supports conveyor mechanism 646 and water supply 648. In this embodiment, continuous farming process 604 can have a smaller footprint than continuous farming process 504 due to the economizing growth media field space and short crop turn-around time. Further, continuous farming process 604 can support perennial-type crops because the root structure can be statically fixed.

FIG. 6C depicts a vertical farming system 600 in a draped array configuration 650. In embodiments, growth media field 630 is draped over a plurality of T-pipes 652. The plurality of T-pipes 652 are coupled to and supported by center frame 654. T-pipes 652 can be used to deliver nutrients, gas, or water to the field. In embodiments, center frame 654 may include separation tabs 656. Separation tabs 656 serve to separate and align growth media fields 630.

Draped array configuration 650 can be configured without the need for fasteners and can therefore reduce labor and material costs. In embodiments, growth media fields 630 can be flat or different widths to create various topography. For example, growth media field 630 segments can be ordered such that a 4″ growth media field 630 is adjacent to an 8″ growth media field 630, which is adjacent to a 12″ growth media field 630. Various combinations of widths of growth media field 630 are appreciated.

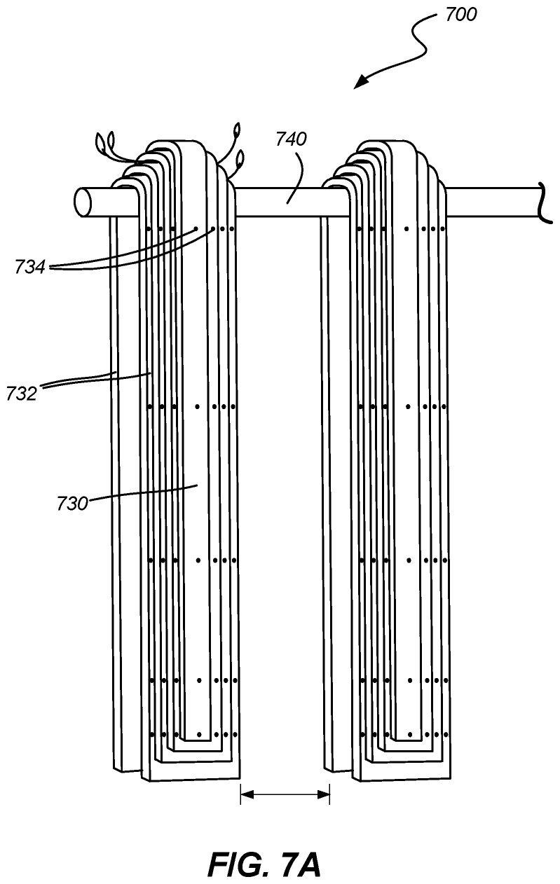

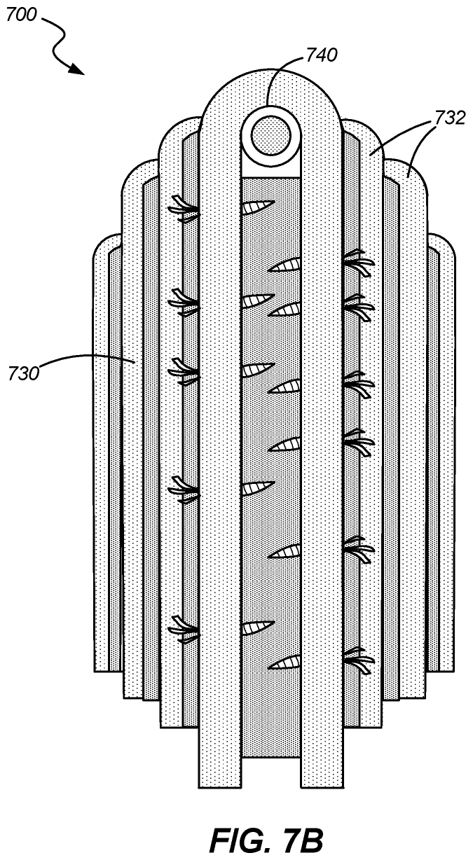

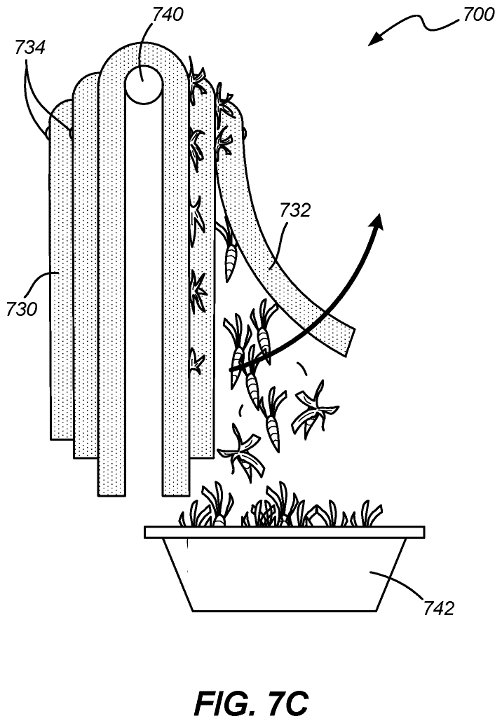

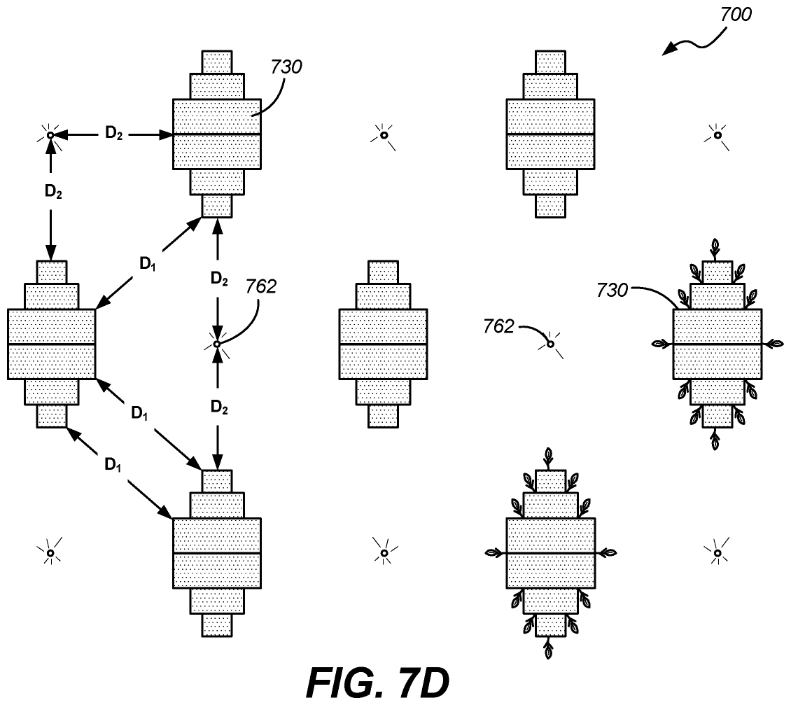

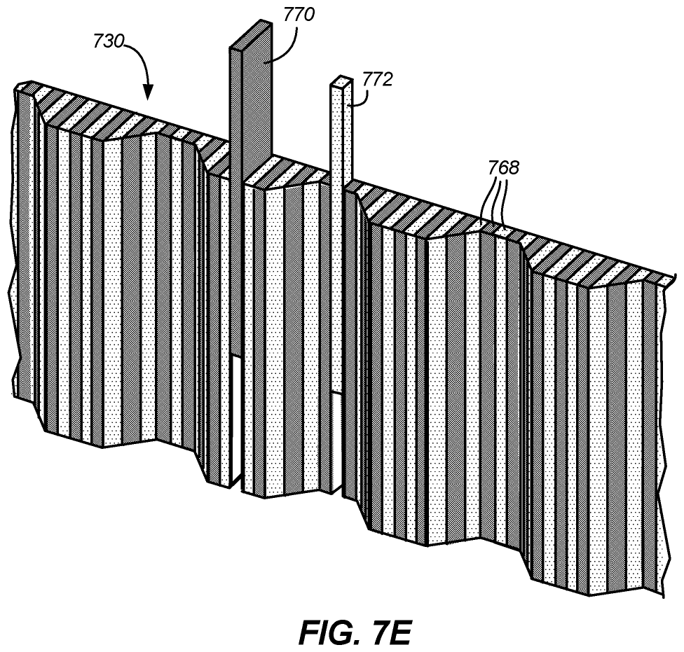

FIGS. 7A-7E depicts an alternative embodiment of vertical farming system 700. Vertical farming system 700 includes a growth media field 730 having one or more media layers 732. Media layers 732 are coupled to one another by fasteners 734. Fasteners 734 can be adhesive, hook and loop, or other suitable weldment. Growth media field 730 is supported by track 740. In this embodiment, a plurality of medial layers 732 are stacked and fastened via fasteners 734 to form a variety of geography. Creating stacked media layer 732 geography creates apertures for row type crops and offers more growth surface area. Further, stacked media layer 732 also provides a growth potential for root vegetables, such as carrots as depicted in FIG. 7B. Further, and as depicted in FIG. 7C, media layers 732 can be separated to aid in root removal and the harvest of root vegetables. In embodiments, a method of harvesting is depicted in FIG. 7C where at harvesting time, media layers 732 can be peeled away and crop is dropped into a collection bin 742.

FIG. 7D depicts a vertical farming system 700 arranged in an optimized array. In embodiments as depicted in FIG. 7D, a plurality of growth media fields 730 can be arranged around a plurality of light sources 762. In embodiments, growth media fields 730 and light sources 762 can be arranged such that each surface of growth media fields 730 can receive an adequate and similar lighting intensity of lighting. In other words, dimensions D1 and D2 remain similar, and constant, throughout the array of growth media fields 730 and light sources 762. FIG. 7E depicts and alternative growth media field 730 composition. In embodiments growth media field 730 comprises alternating media materials 768. Alternating media materials 768 can include a first media 770 and a second media 772 arranged adjacent to each other in a stacked fashion. Further, alternating media materials 768 aperture orientation can be arranged orthogonal to top track 740. In this configuration, minimal or no fasteners are required as suspension alone provides system tension.

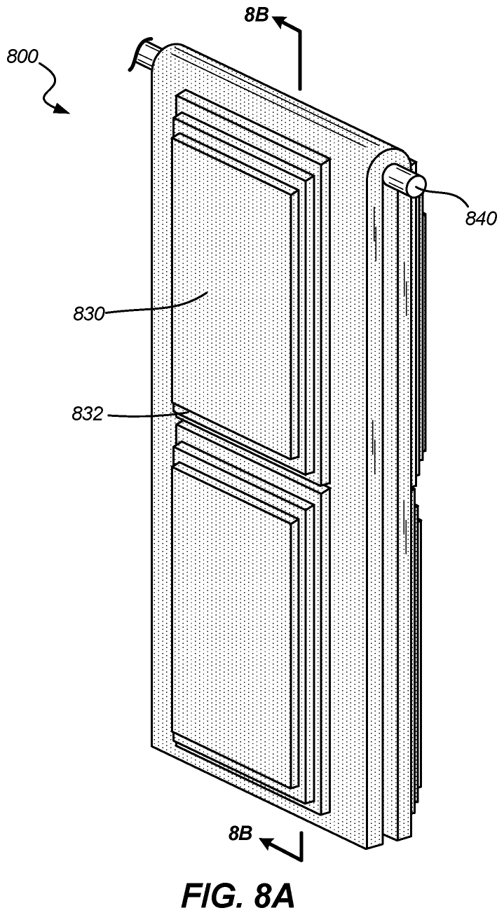

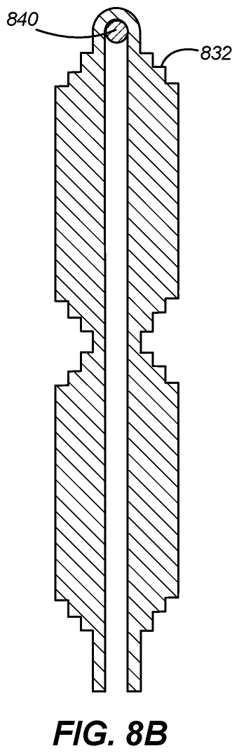

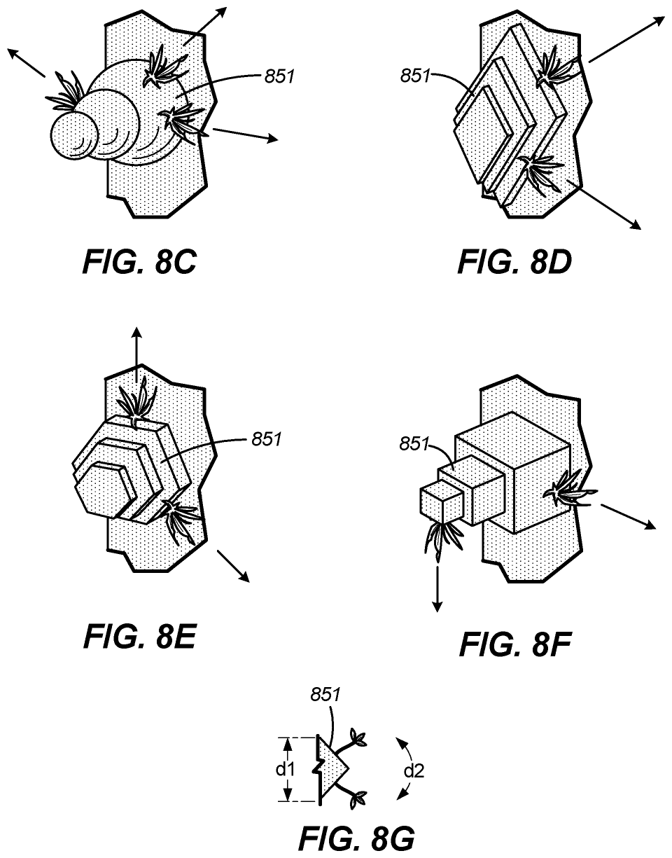

FIGS. 8A-8G, vertical farming system 800, includes a growth media field 830 having one or more media layers 832. In this embodiment as depicted in the cross section view of FIG. 8B, a topographical elevation effect occurs when media layers 832 are stacked. For example, in FIGS. 8C-8G, elevated geography units 851 are created. Specifically, geography units 851 can be formed from fractal-type media layer 832 shapes forming spheres, diamonds, hexagons, cubes, cuboids, pyramids or combination thereof. Further, embodiments depicted in FIG. 8G can benefit from utilizing layers to create apertures, minimize seed spacing and maximizing canopy coverage.

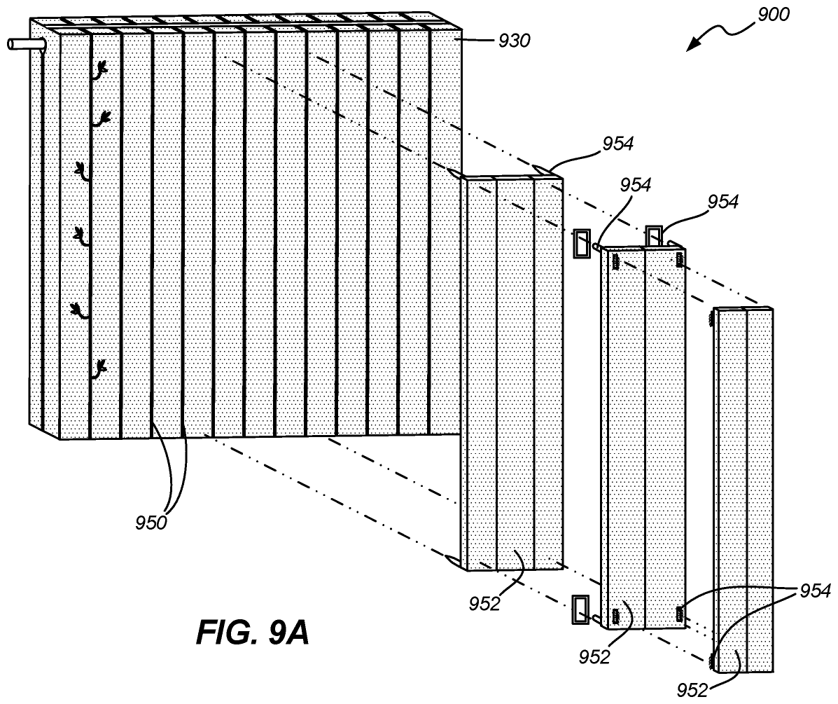

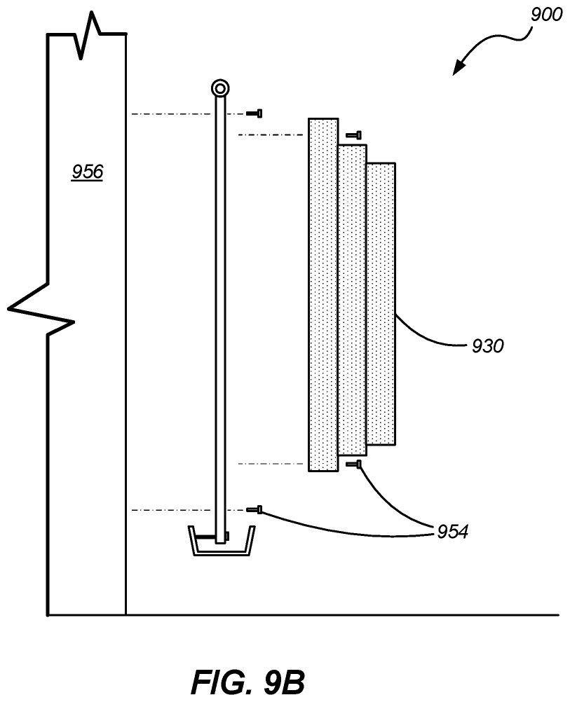

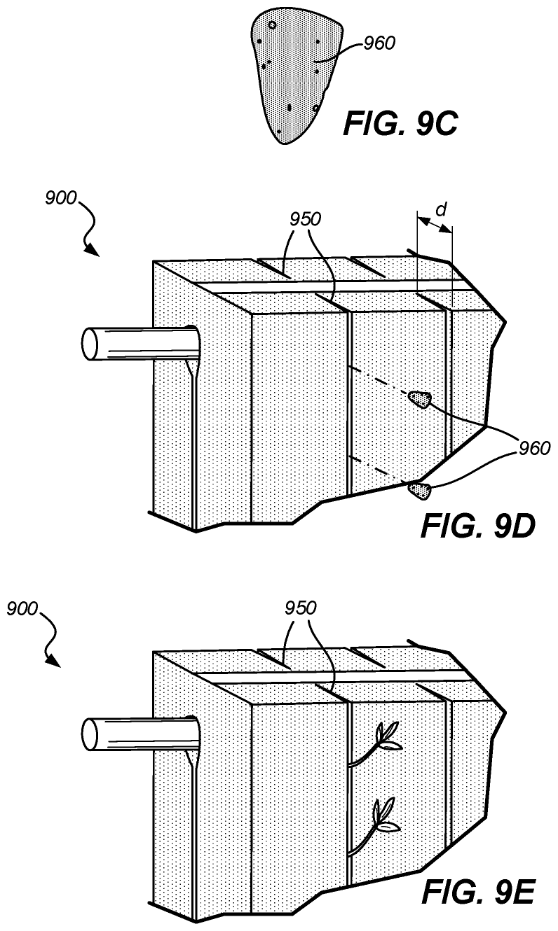

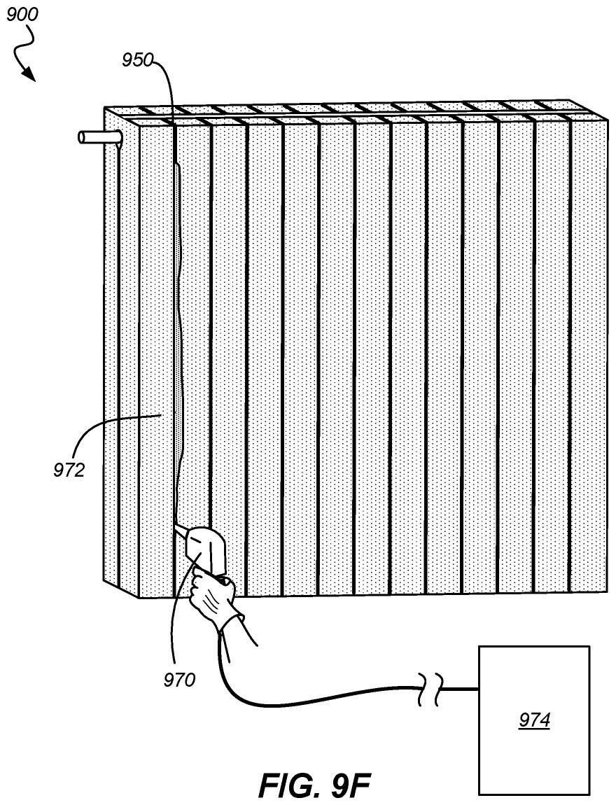

In an alternative embodiment of vertical farming system 900, as depicted in FIGS. 9A-9F, growth media field 930 can comprise growing apertures 950. Growing apertures 950 can be created by combining a plurality of modular layers 952. As depicted in FIG. 9A, growing apertures 950 as well as various combinations of elevated geography, as depicted in FIG. 9B, can be created using modular layers 952. In embodiments, growth media field 930 can be built using modular layers 952 and coupled using various fasteners 954. In an alternative embodiment, growth media field 930 can be a created in a single sided orientation if fixed to a wall 956 as depicted in FIG. 9B.

FIGS. 9C-F depicts various methods of seeding vertical farming system 900. In particular FIG. 9C depicts a seed plug 960. FIGS. 9D and 9E depicts seed plug 960 being inserted into growing apertures 950. In an alternative embodiment as depicted in FIG. 9F, a seed gun 970 injects seed paste 972 into growing apertures 950. Seed paste 972 can be a fluidic mixture of seeds, peat moss and other growth enhancing additives. Seed paste 972 can be stored in seed bin 974 until injected into growing slits 950 via seed gun 970.

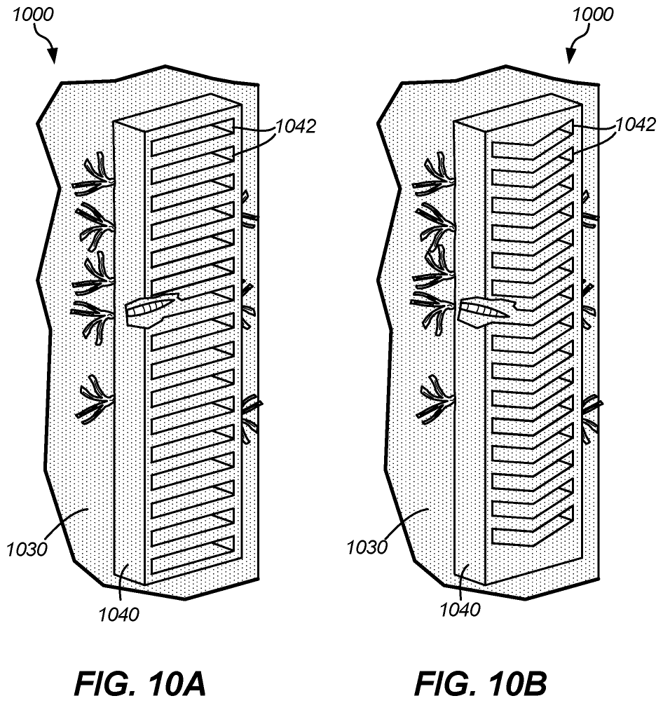

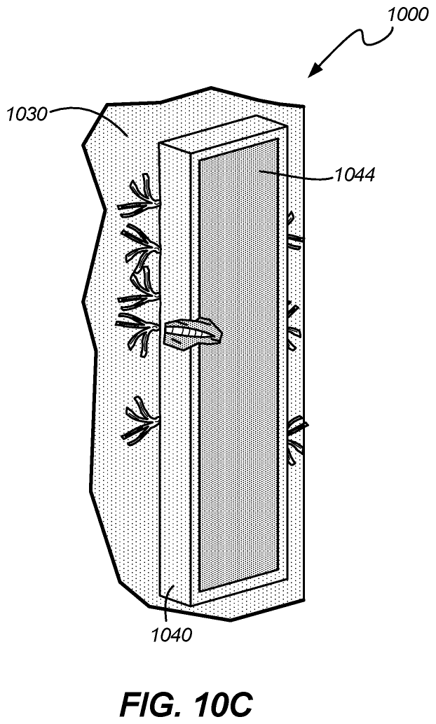

In an alternative embodiment as depicted in FIGS. 10A-10C, vertical farming system 1000 can be configured to include a growth media field 1030. Growth media field 1030 can include a modular piece 1040 arranged on a face of growth media field 1030. Modular piece 1040 can include a plurality of apertures 1042, as depicted in FIGS. 10A-10B, or a single aperture 1044, as depicted in FIG. 10C. Apertures 1042 and aperture 1044 can be vacant or filled with suitable support material, i.e. vermiculite or polymer bound media, such that apertures 1042 and aperture 1044 can create a growth receptacle for root vegetables.

In an alternative embodiment, the vertical farming system can include a cylindrical growth media field. The cylindrical growth media field can be configured to rotate about its axis in a fixed location. Rotation can be used to implement seeding servicing, harvesting, utilize various lighting and growth facilities, or, for use in broadcast seeding. Further, the cylindrical growth media field can be broadcast seeded using a seed solution, a hose, and a seed reservoir.

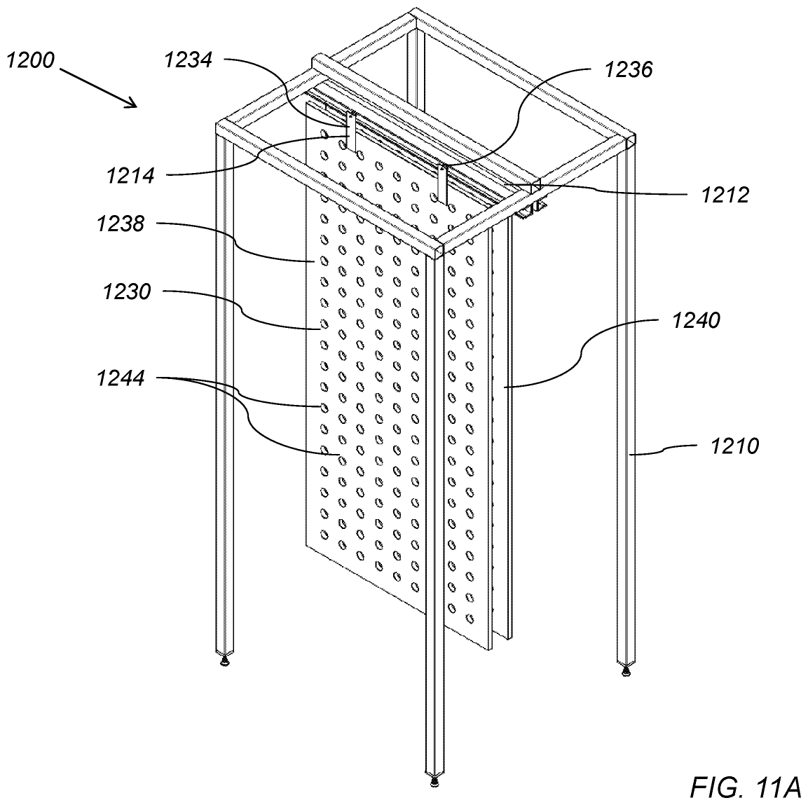

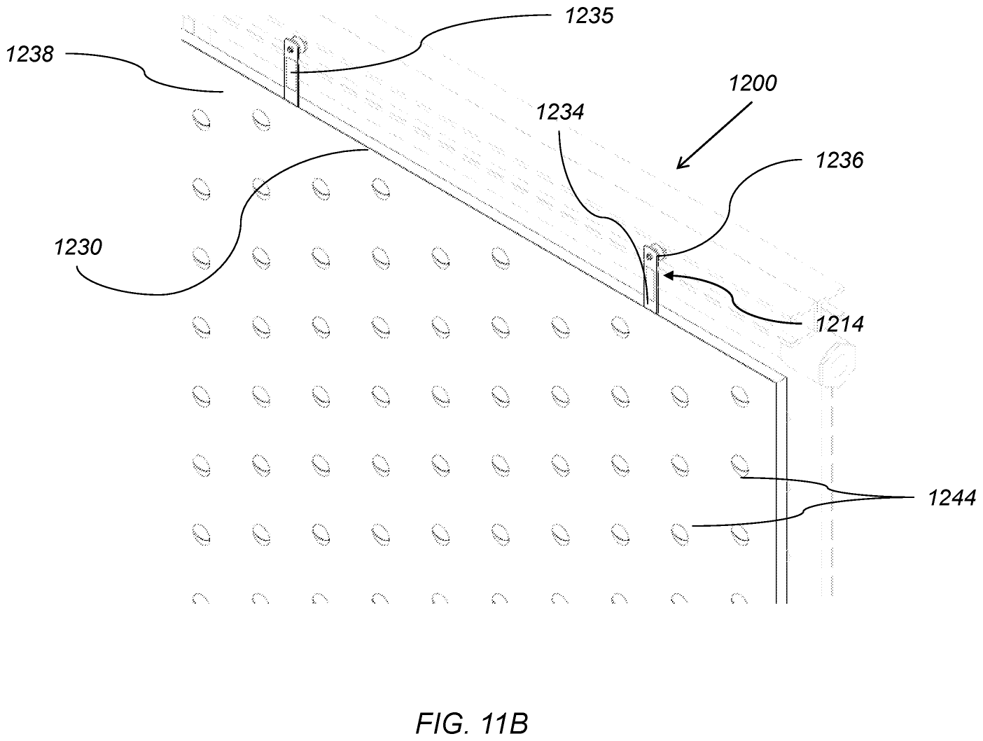

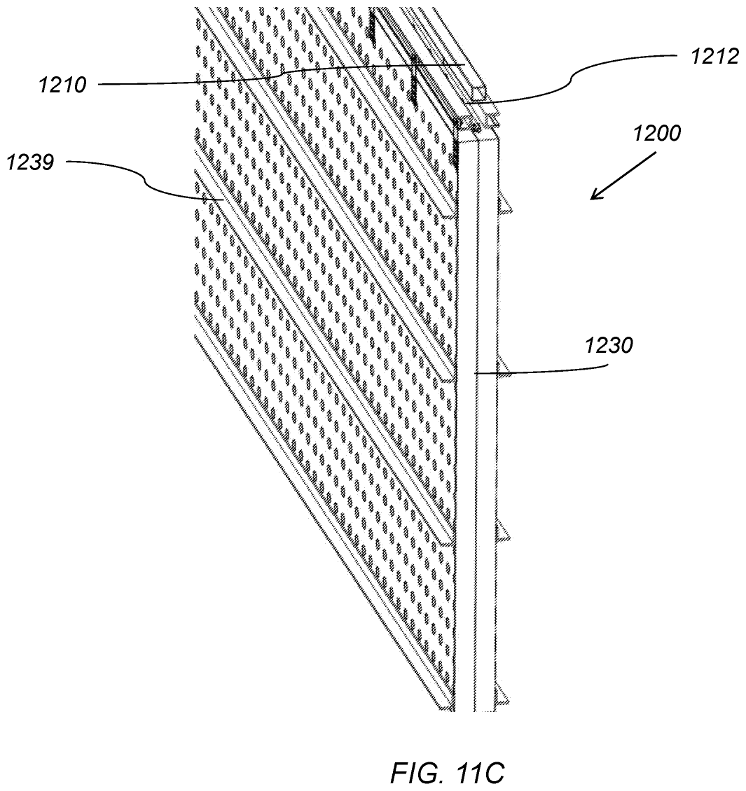

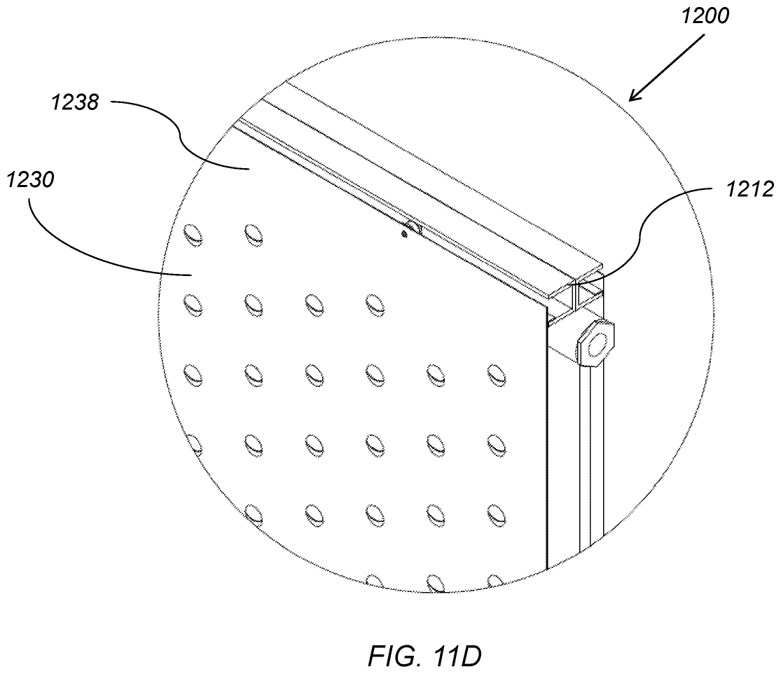

Referring to FIGS. 11A-11D, an embodiment is depicted of a vertical farming system 1200 configured to maximize available growth surface within the confines of a CEA facility. Vertical farming system 1200 includes a support frame 1210, track 1212, a plurality of brackets 1214, and growth media field 1230. In embodiments, support frame 1210 provides suspension support for growth media field 1230 by either mounting to the ground or mounting to other adjacent support structure, such as portions of the CEA facility enclosure. Track 1212 is coupled to support frame 1210 and can be rigidly coupled to support frame 1210 via weldment or selectively coupled to support frame 1210 via fasteners or clips. Growth media field 1230 can be coupled to track 1212 via brackets 1214.

In one embodiment, brackets 1214 can include a fixation plate 1234, on or more strain gauges 1235, and roller 1236. Fixation plate 1234 is configured to rigidly couple to an upper portion of growth media field 1230. For example, and as depicted in FIG. 11B, fixation plate 1234 can be of various lengths and widths and include a nail plate or an array of fixation apertures to affect rigid coupling to growth media field 1230. Alternatively, fixation plate 1234 can be a smooth bracket of various lengths adhered with adhesive or other mechanical fixation. In one embodiment, fixation plate 1234 can include a nail plate having sharp nail portions directed slightly upwards such that the gravitational force of growth media field 1230 aids in securing growth media field 1230 to fixation plate 1234. The one or more strain gauges 1235 can be arranged anywhere on bracket 1214, and for example, on fixation plate 1234. Strain gauges 1235 can be configured to measure strain data of brackets 1214 in order to monitor weight of growth media field 1230. Monitoring the weight of growth media field 1230 allows the user to monitor various parameters, such as crop growth, moisture change, and any other parameter related to weight. Further, strain gauges 1235 provide crop type auditing such that if an unauthorized type of crop is being grown, strain gauges 1235 will record a growth media field 1230 weight that is different than the authorized type of crop. Roller 1236 can be configured to movably couple to track 1212 and roll linearly along the length of track 1212. Growth media field 1230 can then be configured to be linearly movable along track 1212 and support frame 1210. Further track 1212 can be configured to be outwardly open such that track 1212 can accept roller 1236 from a side position as well as at either end of track 1212 (i.e. mount direction non-parallel to the length of track 1212).

In some embodiments, a support layer 1238 can be adhered to the growth surface of growth media field 1230. Support layer 1238 can be made of a plastic, such as BoPET (biaxially-oriented polyethylene terephthalate), metal, or any other suitable material. Support layer 1238 can be adhered to the growth surface of growth media field 1230 using adhesive or mechanical fixation methods. Support layer 1238 serves as a light reflector to maximize reflected light capture and light barrier to prevent algal growth and also serves as a moisture barrier to keep water within interior field and maintain root zone humidity levels. Support layer 1238 serves to provide additional support to growth media field 1230 generally. Support layer 1238 further serves to disperse the fixation load carried by fixation plate 1234.

In yet another embodiment, as depicted in FIG. 11C, growth media field 1230 can include horizontal supports 1239. Horizontal supports 1239 provide additional structural support for large or high weight crops (e.g., tubers, root crops, etc.).

In an alternative embodiment, as depicted in FIG. 11D, support layer 1238 is configured to extend to a bottom surface of track 1212. In this embodiment, support layer 1238 further isolates the root zone environment.

Growth media field 1230 can be sized and shaped to be discrete sections of growth media and can be configured to be pliable or rigid. Growth media field 1230 field thickness can be sized according to crop anchorage requirements. A first growth media field 1230 can be arranged adjacent to a second growth media field 1230 such that there is a growth surface on either side of vertical farming system 1200. Alternatively, a growth media field 1230 can have dual sided exterior growing surfaces for crop growth. Further, growth media field 1230 can have an interior 1240 configured to support and provide fluid distribution to root systems.

In embodiments, interior 1240 of growth media field 1230 can be configured to support and provide fluid distribution to root systems of the crops. Interior 1240 can include a wicking material disbursed across the media pores of the growth media field. In one embodiment, interior 1240 can be rigid to help support growth media field 1230. In an alternative embodiment, interior 1240 can be flexible and/or hollow for aeroponic irrigation.

In one embodiment, growth media field 1230 is be configured to suspend from track 1212. In embodiments, track 1212 can be positioned horizontally at a height conductive to providing support to a top edge of the growth media field 1230. In an embodiment having two growth media fields 1230, two tracks 1212 can be used to support each growth media field 1230, respectively. Alternatively, a single, double sided track 1212 can be used to support both growth media fields 1230. Further, track 1212 can be configured to support irrigation and fertilization supply conduit between or above growth media field 1230. Irrigation and fertilization conduit can be configured to dispense gasses, water or other nutrients to at least interior 1240 of growth media field 1230 and, in some embodiments, to the growth surface of growth media fields 1230.

In FIG. 11A, growth media fields 1230 are independent. In FIG. 11C, growth media fields 1230 are configured to move along tracks 1212 as a single unit. FIG. 11C is configured for growing tubers with interior 1240 sides touching to create a continuous aperture for tubers to grow along the end. At the harvest end of frame 1210, the tracks 1212 become further apart to create a gap so that the interior 1240 aperture is spread to release tubers en masse for collection.

In embodiments, growth media field 1230 can be made of rPET-silica aerogel, coco coir, jute, hemp, burlap, kenaf, wool, felt, peat moss, perlite, vermiculite, rockwool, fiberglass, poly bonded media, synthetic foams, synthetic fibers, or a combination thereof. In some embodiments, polymer bound media can be used. For example, a polymer can be used to bind an organic media, such as peat moss, into a structured and resilient media. With respect to synthetic foams, one example would be reticulated foam, such as reticulated polyurethane. Particularly, growth media field 1230 can contain a plurality of media pore apertures, for example, the pore apertures found in reticulated foam. The media pore apertures can be configured to retain at least one plant seed and/or seedling plant. Further, growth media field 1230 can have a porosity of approximately 8 to 10 media pores per inch. In alternative embodiments, growth media field 1230 can have a porosity that is either greater than 10 pores per inch to accommodate smaller, denser crops, or have a porosity that is smaller than 8 pores per inch to accommodate larger, less dense crops. In some embodiments, growth media field 1230 can include an array of plug apertures 1244. Plug apertures 1244 can be sized and spaced to accommodate plant plugs of a variety of crop types.

In some embodiments, vertical farming system 1200 includes a water-recycle system. The water-recycle system includes a gutter, a sump reservoir, a pump, a water return and a top soaker hose inserted into a pipe. In embodiments, the gutter is configured to house and support a bottom end of growth media field 1230. In alternative embodiments, a non-contacting gap can be arranged between the gutter and the bottom end of growth media field 1230. Further, the gutter is configured to collect excess water that is not absorbed by the crops or held by growth media field 1230. In one embodiment, the gutter is configured to be positioned at an elevated height, or other non-contacting gap, such that a sump output can be arranged on the bottom portion of gutter 152. In one embodiment, the gutter is configured to be suspended from track 1212 thus keeping the entire vertical farm system 1200 freely accessible. In embodiments, top pipe 160 is arranged above growth media field 1230 via the support system. The pipe includes an array of the holes arranged along the pipe. The holes may be arranged in an organized array such as linear holes, or, alternatively, can have a randomized array of holes.

The water-recycle system is configured to capture excess water from growth media field 1230 into the gutter. Then, the excess water exits the gutter through the sump output and is directed into the sump reservoir. From the sump reservoir, water is pumped at a regulated rate through the water return to the pipe. Once at the pipe, the water is dispersed through the holes and onto growth media field 1230 for use in absorption by the crops. In an alternative embodiment, the water return is coupled to track 1212 and configured to disperse recycled water into growth media field 1230 via internal cavity 1240.

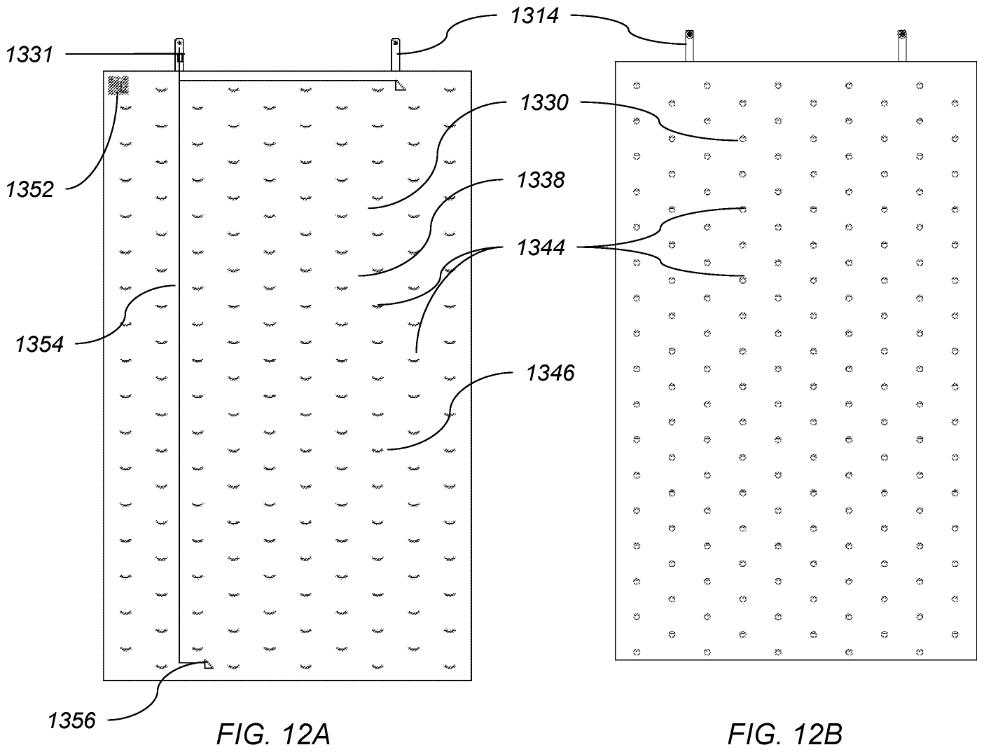

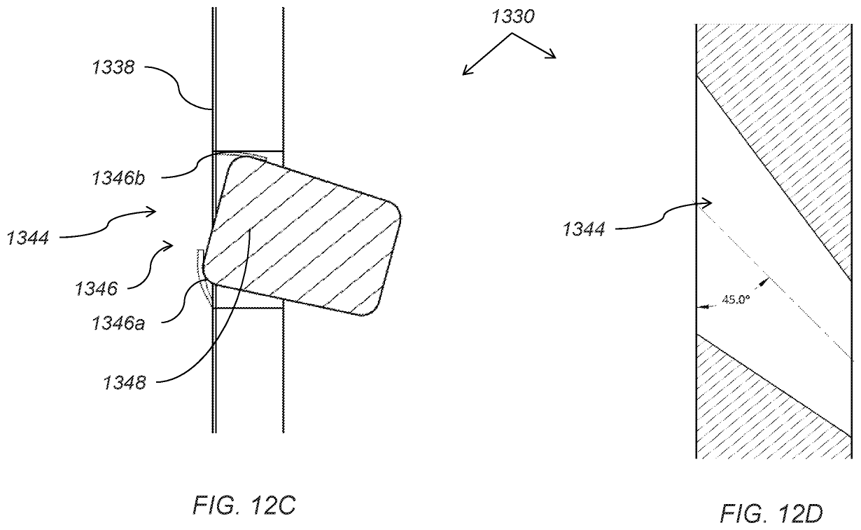

In an alternative embodiment of brackets 1314 and growth media field 1330 are depicted in FIGS. 12A-12B, where FIG. 12A depicts the front side of growth media field 1330 and FIG. 12B depicts the back side of growth media field 1330. In this embodiment, brackets 1314 include one or more strain gauges 1331. In this embodiment, strain gauges 1331 are configure to gauge vertical loads placed on brackets 1314 by growth media field 1330. In this arrangement, strain gauges 1331 can be used to monitor crop growth, moisture content, crop type, and other parameters that can be derived from vertical load data. Further, growth media field 1330 includes an array of plug apertures 1344.

Growth media field 1330 also includes a support layer 1338, which can be adhered to the growth surface of growth media fields 1330. Support layer 1338 can be made of a plastic, such as BoPET, metal, or any other suitable material. In some embodiments, support layer 1338 can include a reflective surface to aid in light conservation. Support layer 1338 can be adhered to the growth surface of growth media field 1330 using adhesive or mechanical fixation methods. Support layer 1338 serves to provide as a light reflector and light barrier to prevent algal growth and also serves as a moisture barrier to keep water within interior field and maintain root zone humidity levels. Support layer 1338 serves to provide additional support to growth media field 1330 generally, and also serves to disperse the fixation load carried by fixation plate 1334 Support layer 1338 further includes an array of arcuate perforations 1346. In this embodiment, perforations 1346 are arcuate in shape, but can alternatively be linear, circular, or any other suitable shape. Arcuate perforations 1346 in a vertical configuration form a supportive, self-centering lower edge 1346a and simultaneously form an upper flap 1346b that is configured to receive objects and further deflect surface fluid away the received objects. When the object is removed, upper flap 1346b returns to the closed position, minimizing light intrusion and field media moisture loss. Lower edge 1346a acts as a drip catch and vertical support for a front portion of plant plug 1348 causing plant plug 1348 to be positioned at an upward angle. The array of arcuate perforations 1346 is arranged on support layer 1338 such that each arcuate perforation 1346 is adjacent to a plug aperture 1344.

In some embodiments, growth media field 1330 can also include a printed surface identifying plant sites. The printed surface can be printed on support layer 1338 or any exposed surface on growth media field 1330. For example, the printed surface could include an X, Y spreadsheet marking each column, row, and plant site. In other examples, the printed surface could include a circular array, spiral array, Fibonacci-based array, or any other array type that would allow special tracking.

Plug apertures 1344 and arcuate perforation 1346, as depicted in FIG. 12C, can be sized and spaced to accommodate plant plugs 1348 of a variety of crop types. Arcuate perforation 1346 can be arranged on support layer 1338 such that when a plant plug 1348 is received by plug apertures 1344 and arcuate perforations 1346, the lower edge of arcuate perforations 1346 acts as a vertical support for a front portion of plant plug 1348 causing plant plug 1348 to be positioned at an upward angle. Positioning plant plugs 1348 at an upward angle allows for a more stable and efficient growth position for plant plugs 1348. In an alternative embodiment, plug aperture 1344 can be tapered and angled to accomplish the same upward plant plug 1348 position.

Support layer 1338 can also include a data tag 1352. Data tag 1352 can include a printed barcode, matrix bar code, radio-frequency identification (RFID), or other suitable data identification device. Tag 1352 is configured to provide crop identification information useful for inventory management and automation. Crop identification information could include crop type, plant date, nutrient application records, plant location and spacing, etc. Tag 1352 can be configured to allow machine reference points to correct robot creep, identify each individual field and what crop is growing and so forth. In some embodiments, the printed surface can include electrically conductive print paths 1354 and monitoring devices 1356.

Electrically conductive print paths 1354 could be configured to communicatively couple monitoring devices 1356 at each plant site to a control system. Printable monitoring devices 1356 can include moisture probes, nutrient level sensors, acidity sensors, optical sensors, etc. Using printable monitoring devices 1356 at each plant site allows the ability to add a plurality of data points such as individual plant site growth characteristics to identify problems, optimize solutions and crop production. Adding instrumentation to the fields can be not only plant site specific data, but also multiple farms to communicate and streamline processes. Instrumentation also allows fraud prevention for example, by identifying a client growing an unlicensed crop. Placing a plurality of solar cells along support layer 1338 borders to harvest excess photons provides the necessary power for active conductive print paths.

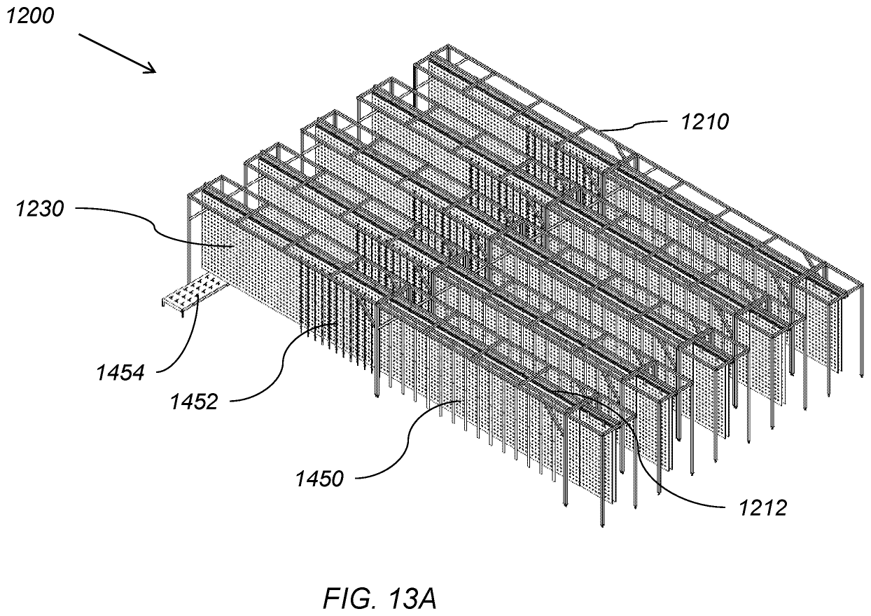

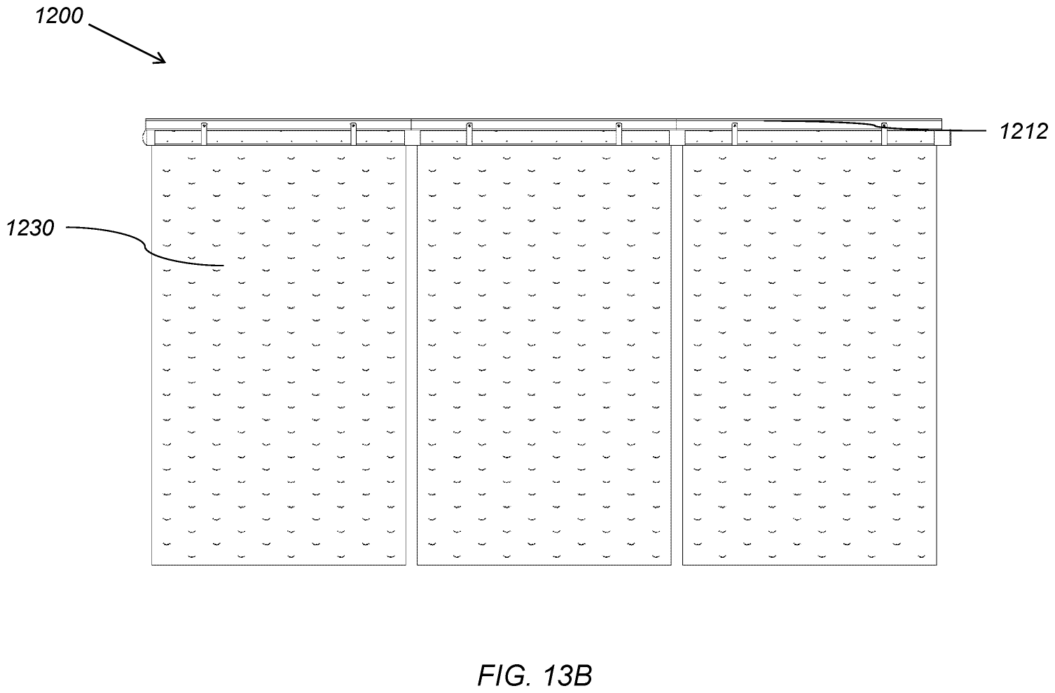

On a full CEA facility scale of vertical farming system 1200, as depicted in FIGS. 13A and 13B, a plurality of growth media fields 1330 or 1230 can be arranged on an elongated support frame 1210 and track 1212. Specifically with respect to FIG. 13B, growth media fields 1330 or 1230 can be loaded adjacent one another on the same frame 1210 and track 1212. Further, and as depicted in FIG. 13A, a plurality of elongated support frames 1210 and tracks 1212 with growth media fields 1330 or 1230 can be arranged adjacent one another within the same facility in order to economically utilize resources of the facility. Vertical farming system 1200 can also include artificial light banks 1450, nutrient emitters 1452, wash station sprayers 1453, and harvest collectors 1454. In embodiments, harvest collectors 1454 can be a tray or conveyor mechanism configured to collect and transport harvested crop and other waste material. In this embodiment, artificial light banks 1450, wash station sprayers 1453, nutrient emitters 1452 and harvest collectors 1454 can be coupled to frame 1210. Artificial light banks 1450, nutrient emitters 1452 and harvest collectors 1454 can be strategically placed at various positions along the length of frame 1210 to accommodate particular growth zones. For example, a higher density of artificial light banks 1450, nutrient emitters 1452 can be placed on a portion of frame 1210 where the crop needs is at a stage of growth requiring more light and nutrients. Similarly, harvest collectors 1454 can be placed at the end of frame 1210 where harvesting occurs. Further, wash station sprayers 1453 can be configured to spray water or water and cleaning agent on the crops when the crops are near harvesting or at any point in the growth cycle. Nutrient emitters 1452 can be configured to spray nutrients, fertilizers, or other components onto the crop at regular intervals, or as needed. In one embodiment, dryer banks can be arranged prior to harvest collectors 1454 such that excess liquid can be removed from the crop prior to harvest.

Growth zones are created when a growth media field 1330 or 1230 is loaded onto the first end of frame 1210 with plant plugs 1348 in an early plant growth stage. Over time, a new growth media field 1330 with plant plugs 1348 in an early plant growth stage is added to the first end, pushing the existing growth media field 1330 with plant plugs 1348 in a matured plant growth stage farther down frame 1210 along track 1212. If a new growth media field 1330 with plant plugs 1348 in an early plant growth stage is added to the first end once a week, for example, then each growth media field 1330 located on a particular frame 1210 will have an additional one week of growing time with respect to the adjacent growth media field 1330 that was added subsequently. Accordingly, each growth media field 1330 located on a particular frame 1210 will have an additional one week less of growing time with respect to the adjacent growth media field 1330 that was added prior to the subject growth media field 1330. In this manner, particular portions of frame 1210 will support growth media fields 1330 at different stages of growth depending on position of a growth media field 1330 along frame 1210. Thus, different growth zones are created along the length of frame 1210.

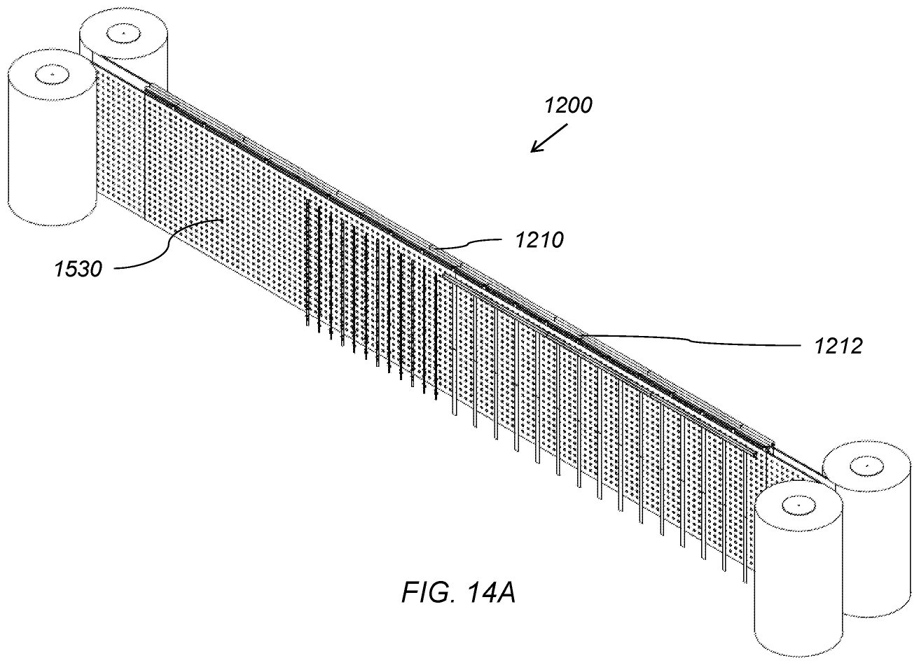

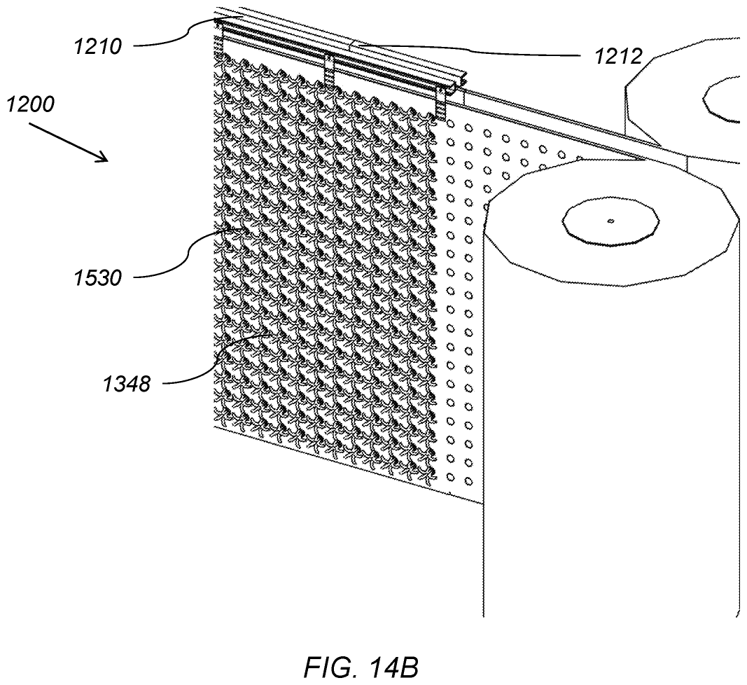

In an alternative embodiment, as depicted in FIGS. 14A and 14B, growth media field 1530 can be configured to be a continuous roll of growth media. In this embodiment, growth media field 1530 can be continuously unrolled to be feed through frame 1210 on track 1212 through the growth zones. In this embodiment, growth zones are created when a growth media field 1530 is unrolled and fed onto the first end of frame 1210 with plant plugs 1348 in an early plant growth stage. Growth media field 1530 is unrolled and fed at a continuous rate. This rate can be commensurate with providing growth media field 1530 with plant plugs 1348 in an early plant growth stage at the first end of frame 1210 and yielding harvestable crop at the second end of frame 1210. In this manner, particular portions of frame 1210 will support growth media fields 1530 at different stages of growth and therefore different growth zones are created along the length of frame 1210.

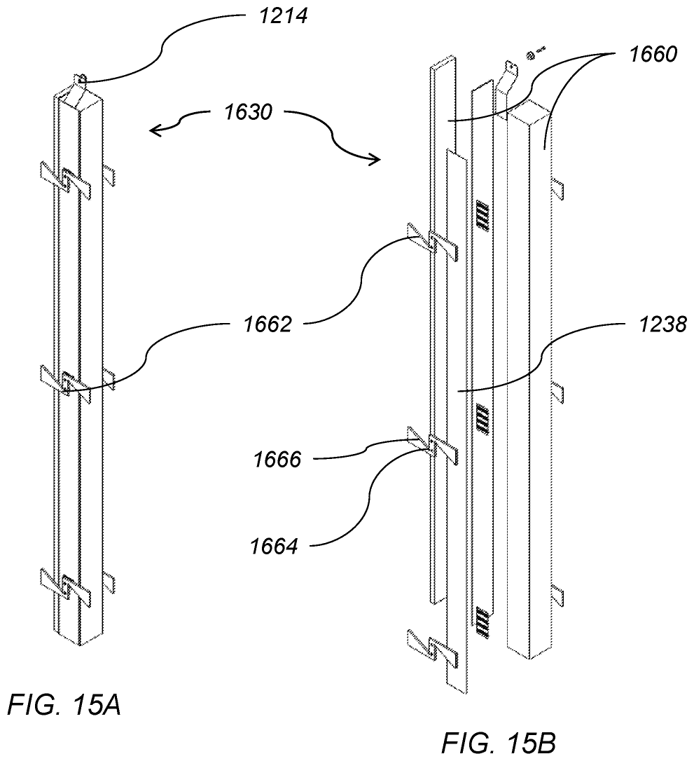

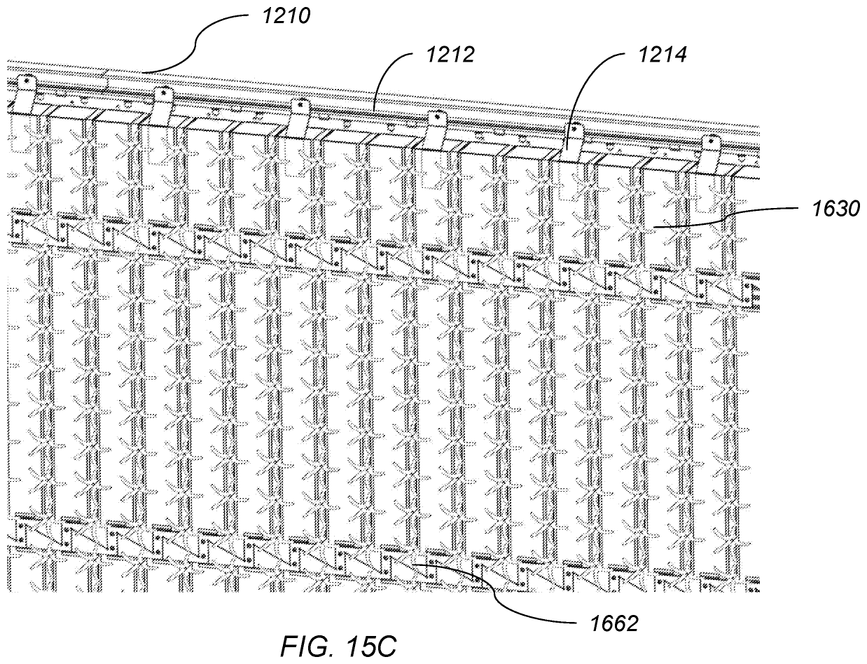

In an alternative embodiment as depicted in FIGS. 15A-C, growth media stacks 1630 can be used to create a growth media field conducive to crop growth. Growth media stacks 1630 can include various growth media layers 1660 stacked together to form growth apertures and supporting media. In this embodiment, the layer composition can be customized to best suit crop output. For example, one layer composition could include a foam layer 1660 and another could include wicking material layer 1660. In another example, the layer composition could include a foam layer 1660, a polymer bound media layer 1660, and a weed mat layer 1660. In an alternative embodiment, the plurality of layers 1660 can be housed in a plastic housing, or otherwise rigid material, and having a front and back aperture opening for plant growth.

In embodiments, growth media stacks 1630 can be coupled to brackets 1214 and configured for use with frame 1210 and track 1212. Further, a support layer 1238 can be added to the outward face of growth media stacks 1630. A plurality of growth media stacks 1630 can be coupled together, as depicted in FIG. 15C, via z-brackets 1662. Z-brackets 1662 can include mounting apertures 1664 and two angled fins 1666. Mounting apertures 1664 are configured to mount to one of the plurality of foam layers 1660 of growth media stacks 1630. Each angled fin 1666 includes an angled edge configured to slidably couple to a corresponding angled fin 1666 of an adjacent z-bracket 1662. Z-bracket 1662 is configured limit horizontal movement between growth media stacks 1630 by interlocking adjacent growth media stacks 1630. In alternative embodiments, clip type brackets, tongue and grove brackets, nail plates, and other types of suitable interlocking hardware can be used.

In embodiments using growth media stacks 1630, growth apertures are created when a growth media stacks 1630 is loaded onto the first end of frame 1210 with plant plugs 1348 in an early plant growth stage positioned in-between layers 1660 as a second growth media stacks 1630 is loaded onto the first end of frame 1210. At a controlled rate, new growth media stacks 1630 with plant plugs 1348 in an early plant growth stage is added to the first end, pushing the existing growth media stacks 1630 with plant plugs 1348 in a matured plant growth stage farther down frame 1210 along track 1212. If a new growth media stack 1630 with plant plugs 1348 in an early plant growth stage is added to the first end once a day, for example, then each growth media stack 1630 located on a particular frame 1210 will have an additional day of growing time with respect to the adjacent growth media stack 1630 that was added subsequently. Accordingly, each growth media stack 1630 located on a particular frame 1210 will have an additional one day less of growing time with respect to the adjacent growth media stack 1630 that was added prior to the subject growth media stack 1630. In this manner, particular portions of frame 1210 will support growth media stack 1630 at different stages of growth depending on position of a growth media stack 1630 along frame 1210. Thus, different growth zones are created along the length of frame 1210.

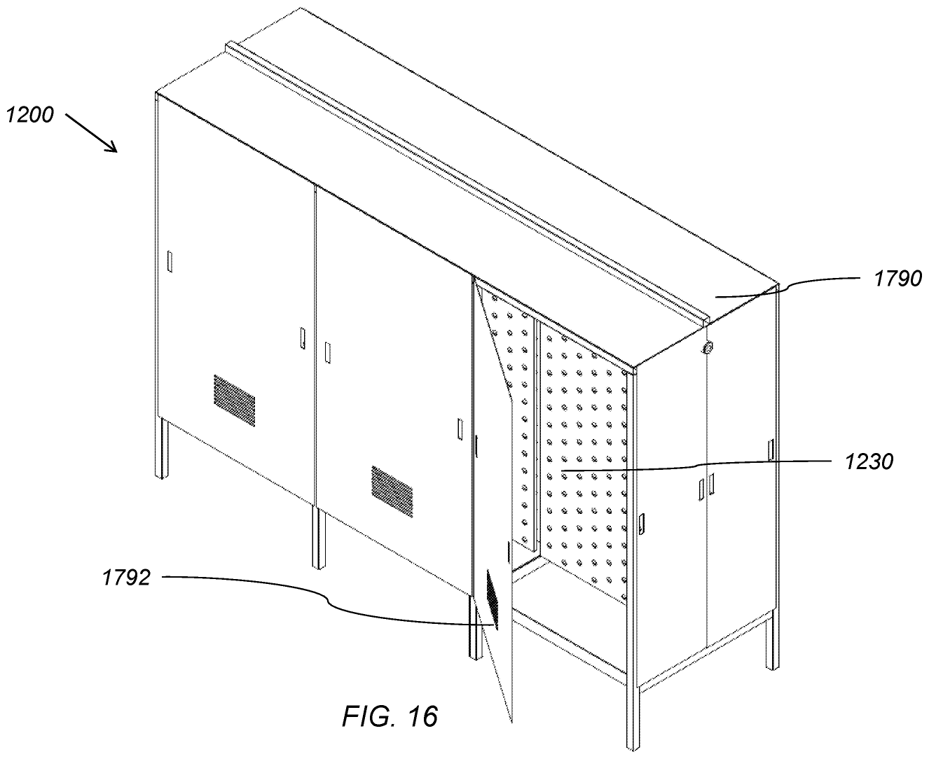

In some embodiments, and as depicted in FIG. 16, vertical farming system 1200 can include a mini-farm enclosure 1790. In this embodiment, mini-farm enclosure can house vertical farming system 1200 within a larger enclosure, such as a greenhouse or warehouse. Mini-farm enclosure 1790 is configured to provide a small, controlled environment for crop growth. Mini-farm enclosure 1790 can include a plurality of access doors 1792. Access doors 1792 can be configured to allow access to growth media fields 1230, 1330 and in some embodiments, allow loading and unloading of growth media fields 1230, 1330. Thus, mini-farm enclosure 1790 can provide a highly controlled growth environment for crops without needing to control the high volume interior of a greenhouse or warehouse.

Further, a crop care robot 192 can be implemented to provide automated care for any field type disclosed herein when equipped with an array of bar codes, matrix bar codes and RFID tags 1352. Using RFID tags 1352 with respect to growth media field 1330, for example, crop care robot 192 can be configured to manage the growth cycles of vertical farming system 1300. In one embodiment crop care robot 192 can receive data from inputs, such as field information from RFID tag 1352, visual information from one or more cameras, and infrared information from infrared receiver. Crop care robot 192 can then send the data to a computing module for analysis and tool instruction. Once a task is received from computing module, the crop care robot tool selector module chooses a tool to complete the instructed task. Tools include seeder, speed loader, manipulator, polymer bound media and seed injector, and cutter.

In embodiments, the one or more layers of the growth media field, and including the support layer, can be coupled together using various adhesives, including micromechanical adhesive, hook and loop fixation, brackets, nail plates, nails, pins, solvent bonding, or any other suitable weldment method.

In use, vertical farming can be configured to maximize available growth surface within the confines of an agricultural environment. For example, vertical farming can include suspending a growth media above the floor of a farming area. The growth media can be a pliable growth field with a dual sided exterior growing surface. Further, the growth field can include an interior that can be configured to form a root zone environment, support and provide nourishment to root systems. Vertical farming can include seeding the growth media over both exterior growing surfaces. Vertical farming can also include providing water and/or nourishment to the growth media via a conduit positioned proximal to a top edge of the growth media. Also, vertical farming can include providing one or more light sources configured to replicate at least a portion of the natural solar spectrum over the exterior growing surfaces.

As an example, the vertical farming system of the present invention includes a growth media useable in a horizontal position, vertical position, or any position between the horizontal position and the vertical position. The reticulated foam growth media field is non rigid, highly portable, being light approx 90% air, making it easy to move from station to station for seeding, grow out, and harvest. The media further allows inclined, multi-angled crop production and multi-storied conveyor style crop production. The growth media of the vertical farm system of the present invention also functions as aquacultural biofiltration/nutrient stripping devices for plant-based, high-efficiency waste nutrient removal and as sites nitrification processes, having massive surface area/volume thereby reducing the costs of single pass aquaculture and improving the efficiency of recirculating aquaculture.

The media of the vertical farm system of the present invention also functions as in-store or at market display devices allowing the display of fresh, live produce for you-pick vegetable sales at market places and allowing the sale of produce that is fresher than traditionally harvested vegetable products. Designed for easy fixation to the walls and/or roofs of buildings, the media reduces heating and cooling costs through shading and plant evapo-transpiration and performs a decorative function.

The vertical farm system of the present invention allows for decorative landscape designs as well as vertical plant production displays indoors for a variety of purposes. The media can house aromatic and decorative species of herbs that may be used for aromatherapy type interactive hallways, lobby displays, kitchen, and cafeteria displays as well as common industrial plant displays in offices and workspaces. The vertical farm system of the present invention also allows for mushroom farming.

The media of the vertical field system of the present invention is non rigid and serves as the form, the function and the irrigation system to create an all in one field system. The media can be manufactured to the thickness required for any crop class and plant anchorage requirement. The top track can be linear or sine wave to economically fit more field area in a given footprint. The media is simply draped over the top track to create the two sided vertical field. The media can be shipped bulk and is cut to the size desired. The gutter can be attached to the bottom of the media field to provide media stability and prevent the media from sliding. In a continuous farm environment, the gutter can be stationary and also act as a media guide and bottom barrier of the root zone environment. A center frame can be used to minimize field movement and thus prevent root damage. The media can be a closed vertical loop, wherein the loop would cycle crop from seed to harvest for one elevation seeding and finally, to one elevation harvesting.

The sump returns the water to the top soaker hose to irrigate the field. The media is composed of any number of materials, and is suspended on the top track vertically from the ceiling. The top track is supported by a framework and/or standing upright on the floor using a support pole or frame.

The media field is representative of an Earth terrestrial field and any number of terrestrial geographic features such as flat, mountains and ravines. The media field can be on a vertical plane. The media can be constructed of one or many different materials to create the exact field characteristics desired for a particular crop. Some characteristics include: field strata, root anchorage, aerobic root zones, irrigation flow rates, humidity control, field depth etc.

For root vegetables, a plurality of apertures extending along predefined axis act as a void space. Void space can be filled with stretchy media such as polymer bound media or loose fill that allows the tubers to grow uninhibited.

Further, the media can be engineered with any number of impregnated materials and coatings for the desired field performance characteristics. These characteristics can include even moisture distribution throughout the field strata. To hold water in and evenly control humidity levels, coatings such as a wax can be utilized to form an external barrier. This barrier can be colored white or silver to maximize light reflection and light diffusion.

As an alternative to non-rigid media, a rigid form can create ease of use benefits. To create rigid media, the modular layer media pieces can be impregnated or coated. If desired, a separate, rigid exoskeleton could be used. Such an exoskeleton could be made with corrugated plastics or even PVC and utilize low cost extrusion methods.

The media can be of various thicknesses. Media thickness can accommodate root requirements, plant anchorage and farm area. Accordingly, media thicknesses of the double sided field may be about 3 to 4 inches thick depending on crop requirements and available manufacturing sizes. Seed spacing becomes a limiting factor as each plant requires individual spacing requirements to grow properly.

To reduce seed spacing, fractal-type protrusions can be placed on the media face. Protrusions increase available growth surface. Stepped layers of media can start, for example, at 12 inches wide at the base, the next layer is also 3 inches thick and 8 inches wide and finally the third layer is 3 inches thick, and 4 inches wide. Utilizing fractal-type protrusions optimizes plant density and canopy coverage.

Additionally, the media field can be broadcast seeded and/or have any number of ingredients in a slurry mixture applied directly to field surface. For example, seeds or mushroom spores will fixate within media pores. To increase fixation, a seed adherent can be added to slurry mix to help seeds adhere to field surface.

Additionally, to minimize the use of propagation tables for row type crops, the system is designed to be seeded in situ. The unique combination of media field with a combination of materials used, and establishing micro climates accelerates production. By directly controlling the aperture orientation, and light placement in proximity to each aperture, seedlings are coaxed to grow along the path of least resistance.

In vertical farming systems, according to inventions herein, the field growing season can be controlled at each stage of development. Climate control can be accomplished by micro climate control by utilizing field tents that will attach to the exoskeleton of the field frame. The frame allows the fields to be suspended from the top such that there is no ground contact. This is beneficial because crops create extensive plant waste during a growing season which must be removed and maintained by labor. Ergonomically, existing systems require repeatedly bending over and lifting boxes, vacuuming etc. Eliminating these unnecessary steps, increases system efficiency. Carts can be used to collect harvest or a table can be suspended below the field. With this arrangement, crop harvest can fall directly into bulk collection bins, blister packs, or bags.

The container can then be removed using a conveyor system. An exoskeleton surrounding each field allows any number of devices to be attached, such as a field tent to establish a micro climate, lighting, additional rails for vine plants to attach to. Further, an X, Y, Z axis robot can be implemented to plant, maintain, and harvest crops.

As the media is used, the roots from crops will bind the system together. Over several years, a complete field biome can exist. For example, worms can be added to the media to eat and digest root matter. Further, azotobacter cultures can be introduced to fixate nitrogen and legumes may be introduced into crop rotation practices to accomplish the same.

In an embodiment, a pump moves nutrient solution from a nutrient solution reservoir to the metered pipe. The pipe acts as an overhead, low pressure reservoir. When the solution reaches the holes in the pipe, the field is gravity irrigated. A soaker hose may be placed in a pipe or covered by another layer or be partially covered. Aeroponic or emitters can also be used. A nutrient solution can drip down through the media and plant roots. High humidity can be maintained within the root zone due to the constant trickling/misting of nutrient solution and coatings applied.

The height of the plant field is variable dependent on indoor farm ceiling height, and the spacing for plants is variable dependent on plant type and desired spacing. Vertical field spacing is a function of plant canopy requirements and level of farm automation and harvest methods such as selective harvesting or one time harvesting. It is possible to have media of any length and width to fill any volumetric space available. The system can either be mounted to the ceiling, or as part of the superstructure frame. The top track can be configured to utilize conveyor production techniques to move a crop such as wheat through each growth stage and finally to harvest. The media of the vertical farm system of the present invention can also be altered in several ways to serve a diverse range of functions. Tops, bottoms, sides, and corners of the media can also be cut, rounded, or cut at an angle to reduce bio solids accumulation, algal growth, or to enhance water distribution through the media depending on application. Front and back of the media can be cut or sliced to create full or partial depth apertures to aid in crop production, ease of root mass removal and field servicing depending on application.

The apertures can be defined as the media pores, manufactured spaced plant site plug holes, partial or full depth linear lines, and between layers that act as crop rows. In this manner, the pores can be broadcast seeded. The plug holes can be injected with polymer bound media and seed or plugs may be inserted. The linear lines offer high speed mechanical seeding methods such as: broadcast, injection, plugs and speed loading paper cup, seed tape or a plant tape for low cost ease of use.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A vertical farming system configured to form a root zone environment, support and provide fluid distribution to root systems of crops via a multilayered growth media within an agricultural environment, the vertical farming system comprising:
a multilayered growth media including a root system anchorage layer configured to support and provide fluid distribution to the root systems of crops, and a supporting layer fixed to an exterior surface of the root system anchorage layer, the supporting layer configured to act as a containment barrier for the root zone environment, fluid distribution within the root system anchorage layer and to promote a distribution of stress from the one or more track engaging brackets across the exterior surface of the root system anchorage layer.

2. The vertical farming system of claim 1, wherein the supporting layer has a thickness between about 25.4 and about 4000 μm.

3. The vertical farming system of claim 1, wherein the vertical farming system is configured to create a root zone environment between a top barrier formed from a bottom surface of the track, a side barrier formed from the multilayered growth media and a bottom barrier formed from a gutter.

4. The vertical farming system of claim 1, wherein the supporting layer defines a plurality of perforations configured to enable a portion of a crop to pass therethrough.

5. The vertical farming system of claim 4, wherein the perforations include at least one arcuate edge configured to promote the containment of fluid distribution within the root system anchorage layer.

6. The vertical field system of claim 1, wherein the multilayered growth media includes a plurality of apertures, the apertures being sized and shaped to support one or more plant site.

7. The vertical farming system of claim 1, wherein the supporting layer defines a printable surface including one or more electrically conductive print paths.

8. The vertical farming system of claim 1, wherein the root system anchorage layer has a thickness between about 0.2 and about 12 inches.

9. The vertical farming system of claim 1, wherein the root system anchorage layer is constructed of a polymer bound material.

10. The vertical field system of claim 1, wherein the growth media is divisible into a plurality of stacked layers, wherein the stacked layers are arranged such that a channel is formed from an intersection of the stacked layers such that plant growth can occur within the channel.

11. The vertical farming system of claim 1, wherein the multilayered growth media is comprised of one or more growth media discrete sections.

12. The vertical farming system of claim 1, wherein the multilayered growth media is suspended from a suspended track, such that a non-contacting gap is defined between the bottom edge of the growth media and a floor of the agricultural environment.

13. The vertical farming system of claim 13, wherein the multilayered growth media is initially comprised as a roll of material configured to be unrolled into flexible multilayered growth media as it is suspended from the suspended track.

14. The vertical field system of claim 13, wherein the multilayered growth media include brackets coupled to a portion of the multilayered growth media, the brackets further including strain gauges.

15. The vertical farming system of claim 13, wherein the suspended track of the multilayered growth media is configured such that the multilayered growth media is selectively coupleable to the suspended track from a side position at any portion of the suspended track.

16. The vertical farming system of claim 13, wherein the suspended track forms a top barrier of a root zone environment.

17. The vertical farming system of claim 17, wherein the root zone environment is uninterrupted throughout the length of the growth media.

18. The vertical farming system of claim 1, wherein the multilayered growth media defines a root zone environment barrier, wherein the support layer forms the exterior of the root zone environment, synthetic foam forms the root anchorage zone, and a polymer bound media forms an interior boundary.

19. The vertical farming system of claim 19, the root zone environment is defined as a plurality of distinct root zones.

20. A root zone environment configured for use with a vertical farming system, support and provide fluid distribution to root systems of crops via a suspended, multilayered growth media within an agricultural environment, the root zone environment comprising:
a multilayered growth media including:
a root system anchorage layer configured to support and provide fluid distribution to the root systems of crops, and
a supporting layer fixed to an exterior surface of the root system anchorage layer, the supporting layer configured to act as a containment barrier for the root zone environment, and fluid distribution within the root system anchorage layer; and
a top barrier coupled to a top edge of the multilayered growth media.
